(19) United States
(12) Patent Application Publication
(10) Pub. No.: US 2024/0322698 A1
(43) Pub. Date: Sep. 26, 2024

(54) POWER CONVERSION DEVICE, VEHICLE, CONTROL METHOD, AND COMPUTER PROGRAM PRODUCT

(71) Applicant: Panasonic Intellectual Property Management Co., Ltd., Osaka (JP)

(72) Inventor: Fumito KUSAMA, Osaka (JP)

(21) Appl. No.: 18/429,123

(22) Filed: Jan. 31, 2024

(30) Foreign Application Priority Data
Mar. 22, 2023 (JP) 2023-045015

(51) Int. Cl. H02M 3/335; B60L 50/60; H02M 1/00; H02M 1/088; H02M 3/00

(52) U.S. Cl. CPC H02M 3/33573; B60L 50/60; H02M 1/0022; H02M 1/088; H02M 3/01; H02M 3/33592; B60L 2210/10

(57) ABSTRACT

A power conversion device according to the present disclosure is applied with a DC input voltage and outputs a DC output voltage to a load. The power conversion device includes first to fourth switch elements, a resonance circuit including an inductor and a capacitor, a transformer in which the inductor, the capacitor, and a primary-side coil are connected in series, a rectifier circuit, a smoothing circuit, and a controller. The controller controls an operation frequency, simultaneously switches the first and fourth switch elements in a first mode, and switches the fourth switch element with a phase of the fourth switch element delayed by a predetermined first phase with respect to the first switch element in a second mode. The controller switches the first and second modes according to at least one of the output voltage, an output current, a dead time current, the input voltage, and a circuit temperature.

### CROSS-REFERENCE TO RELATED APPLICATIONS

This application is based upon and claims the benefit of priority from Japanese Patent Application No. 2023-045015, filed on Mar. 22, 2023, the entire contents of which are incorporated herein by reference.

### FIELD

Embodiments described herein relate generally to a power conversion device, a vehicle, a control method, and a computer program product.

### BACKGROUND

As a power conversion device, an LLC resonance type DC-DC converter using a transformer has been known. Such a power conversion device is used, for example, for charging an in-vehicle lithium ion battery in a vehicle such as an electric vehicle.

Incidentally, in such a power conversion device, an iron loss and a loss due to an excitation current may increase. When the power conversion device is used under conditions that the iron loss and the loss due to the excitation current increase, the power conversion device has to include a cooling mechanism for cooling a transformer or include a transformer having a coil with a large core size. For this reason, the power conversion device used under such conditions has been increased in scale and cost.

The document “Umme Mumtahina and Peter Joseph Wolfs, “Multimode Optimization of the Phase Shifted LLC Series Resonant Converter”, IEEE Transactions on Power Electronics, Volume: 33 Issue: 12, P. 10478-10489, Dec. 1, 2018” describes an operation analysis and an operation verification result at the time of phase shift control and describes that phase shift control is performed when an output voltage is low and an output current is low. JP 2016-63745 A describes performing phase shift control when an output voltage is not within an allowable operation range and an operation frequency exceeds a predetermined maximum frequency. In WO 2022/153723 A, frequency modulation control and phase shift control are switched and executed and, when the frequency modulation control and the phase shift control are switched, overlap control for executing the phase shift control while executing the frequency modulation control is executed in a predetermined switching operation range. FIG. 3 and FIG. 9 of WO 2022/153723 A describe that phase shift is performed when an output voltage is low and an output current is low.

However, none of the documents describes a control method under conditions that the iron loss and the loss due to the excitation current increase. Thus, the iron loss and the loss due to the excitation current cannot be sufficiently reduced. When the phase shift control is performed, because the output power does not simply increase or decrease with respect to a phase shift amount under conditions that the output voltage is high, it is difficult to control the power conversion device.

### SUMMARY

A power conversion device according to an embodiment of the present disclosure, in which a DC input voltage is applied between a positive-side input terminal and a negative-side input terminal and a DC output voltage is output from between a positive-side output terminal and a negative-side output terminal connected to a load, includes: a first switch element connected between the positive-side input terminal and a first intermediate terminal; a second switch element connected between the first intermediate terminal and the negative-side input terminal; a third switch element connected between the positive-side input terminal and a second intermediate terminal; a fourth switch element connected between the second intermediate terminal and the negative-side input terminal; a resonance circuit including an inductor and a capacitor; a transformer in which a primary-side coil is connected between the first intermediate terminal and the second intermediate terminal such that the inductor, the capacitor, and the primary-side coil are connected in series; a rectifier circuit configured to rectify a voltage output from a secondary-side coil of the transformer; a smoothing circuit configured to smooth a voltage output from the rectifier circuit and output the smoothed voltage between the positive-side output terminal and the negative-side output terminal; and a controller configured to complementarily switch the first switch element and the second switch element with an operation frequency and complementarily switch the third switch element and the fourth switch element with the operation frequency. The controller is configured to: control the operation frequency to set an output current supplied to the load or output power supplied to the load to a preset target value; simultaneously switch the first switch element and the fourth switch element in a first mode; switch the fourth switch element with a phase of the fourth switch element delayed by a predetermined first phase with respect to the first switch element in a second mode; and switch the first mode and the second mode according to at least one of the output voltage, the output current, a dead time current flowing to the inductor in a dead time from when the fourth switch element becomes nonconductive until when the third switch element is conducted, the input voltage, and a circuit temperature, which is a temperature of the transformer.

### BRIEF DESCRIPTION OF THE DRAWINGS

FIG. 1 is a diagram illustrating a configuration of a power conversion device according to an embodiment;

FIG. 2 is a diagram illustrating a Q1 signal, a Q2 signal, a Q3 signal, and a Q4 signal in a first mode;

FIG. 3 is a diagram illustrating a Q1 signal, a Q2 signal, a Q3 signal, and a Q4 signal in a second mode;

FIG. 4 is a flowchart illustrating switching processing for a first mode and a second mode;

FIG. 5 is a diagram illustrating a simulation result of a characteristic of output power with respect to an operation frequency in an LLC converter;

FIG. 6 is a diagram illustrating a simulation result of a characteristic of an iron loss with respect to output power in the case in which an input voltage is fixed in the LLC converter;

FIG. 7 is a diagram illustrating a simulation result of a characteristic of an iron loss with respect to output power in the case in which an output voltage is fixed in the LLC converter;

FIG. 8 is a diagram illustrating waveforms in the case in which an input voltage is Vin.typ, an output voltage is Vout.max, output power is 7 W, an operation frequency is fc1, and an iron loss is Pi1 in the LLC converter;

FIG. 9 is a diagram illustrating waveforms in the case in which an input voltage is Vin.typ, an output voltage is Vout.typ, output power is 48 W, an operation frequency is fc2, and an iron loss is Pi2 in the LLC converter;

FIG. 10 is a diagram illustrating waveforms in the case in which an input voltage is Vin.typ, an output voltage is Vout.min, output power is 34 W, an operation frequency is fc3, and an iron loss is Pi3 in the LLC converter;

FIG. 11 is a diagram illustrating waveforms in the case in which an input voltage is Vin.max, an output voltage is Vout.max, output power is 39 W, an operation frequency is fc4, and an iron loss is Pi4 in the LLC converter;

FIG. 12 is a diagram illustrating a simulation waveform in the case in which a current is fed to a load in the LLC converter;

FIG. 13 is a diagram illustrating a simulation waveform at the time of no load in the power conversion device;

FIG. 14 is a diagram illustrating a simulation waveform at the time of load connection in the power conversion device;

FIG. 15 is a diagram for explaining an Idet margin;

FIG. 16 is a diagram illustrating a simulation waveform of a primary-side current at the time of load connection in the power conversion device;

FIG. 17 is a diagram illustrating output power with respect to an operation frequency in the case of operation under a first condition;

FIG. 18 is a diagram illustrating an iron loss with respect to output power in the case of the operation under the first condition;

FIG. 19 is a diagram illustrating an Idet margin with respect to output power in the case of the operation under the first condition;

FIG. 20 is a diagram illustrating output power with respect to an operation frequency in the case of operation under a second condition;

FIG. 21 is a diagram illustrating an iron loss with respect to output power in the case of the operation under the second condition;

FIG. 22 is a diagram illustrating an Idet margin with respect to output power in the case of the operation under the second condition;

FIG. 23 is a diagram illustrating output power with respect to an operation frequency in the case of operation under a third condition;

FIG. 24 is a diagram illustrating an iron loss with respect to output power in the case of the operation under the third condition;

FIG. 25 is a diagram illustrating an Idet margin with respect to output power in in the case of the operation under the third condition;

FIG. 26 is a diagram illustrating output power with respect to an operation frequency in the case of operation under a fourth condition;

FIG. 27 is a diagram illustrating an iron loss with respect to output power in the case of the operation under the fourth condition;

FIG. 28 is a diagram illustrating an Idet margin with respect to output power in the case of the operation under the fourth condition;

FIG. 29 is a flowchart illustrating processing in a first modification;

FIG. 30 is a diagram illustrating a characteristic of output power with respect to an operation frequency in the case in which the magnitude of a phase is changed;

FIG. 31 is a diagram illustrating a characteristic of an iron loss with respect to output power in the case in which the magnitude of the phase is changed;

FIG. 32 is a diagram illustrating a characteristic of an Idet margin with respect to an output voltage in the case in which the magnitude of the phase is changed;

FIG. 33 is a flowchart illustrating processing in a second modification;

FIG. 34 is a diagram illustrating a characteristic of output power with respect to operation frequencies in a first mode and a second mode;

FIG. 35 is a diagram illustrating a characteristic of an iron loss with respect to output power in the first mode and the second mode;

FIG. 36 is a diagram illustrating a characteristic of an Idet margin with respect to output power in the first mode and the second mode;

FIG. 37 is a characteristic diagram of output power with respect to a phase shift amount in the case in which phase shift control is performed with a frequency fixed by a configuration of a conventional LLC converter;

FIG. 38 is a characteristic diagram of an iron loss with respect to output power in the case in which the power conversion device is caused to operate under the conditions of FIG. 37 by the configuration of the conventional LLC converter; and

FIG. 39 is a flowchart illustrating processing in a third modification.

### DETAILED DESCRIPTION

Embodiments of a power conversion device 10 according to the present disclosure will be explained below with reference to the accompanying drawings.

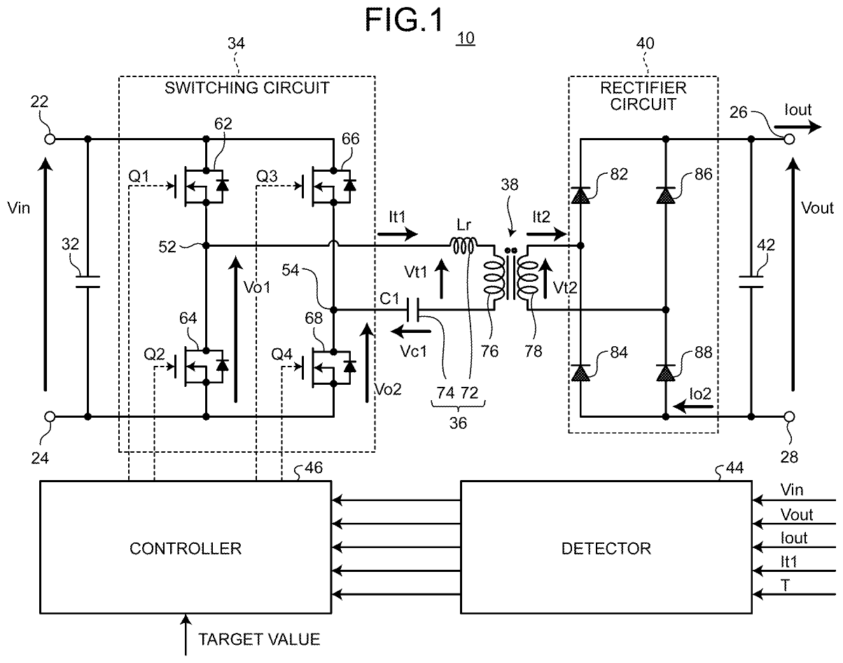

FIG. 1 is a diagram illustrating a configuration of a power conversion device 10 according to the embodiment. The power conversion device 10 receives a DC input voltage Vin from a pre-stage device, converts the received DC input voltage Vin into a DC output voltage Vout, and supplies the output voltage Vout to a post-stage device functioning as a load. In the present embodiment, the power conversion device 10 is an LLC resonance type DC-DC converter.

The power conversion device 10 includes a positive-side input terminal 22, a negative-side input terminal 24, a positive-side output terminal 26, a negative-side output terminal 28, an input capacitor 32, a switching circuit 34, a resonance circuit 36, a transformer 38, a rectifier circuit 40, a smoothing circuit 42, a detector 44, and a controller 46.

The power conversion device 10 receives the DC input voltage Vin from the pre-stage device between the positive-side input terminal 22 and the negative-side input terminal 24. A voltage higher than a voltage applied to the negative-side input terminal 24 is applied to the positive-side input terminal 22. Note that each of the positive-side input terminal 22 and the negative-side input terminal 24 may not be provided with a pad, an electrode, or the like if an electrical contact is present and may be, for example, a wire or a cable.

The power conversion device 10 outputs the DC output voltage Vout from between the positive-side output terminal 26 and the negative-side output terminal 28 to the load. In the positive-side output terminal 26, a voltage higher than a voltage in the negative-side output terminal 28 is generated. Note that each of the positive-side output terminal 26 and the negative-side output terminal 28 may not be provided with a pad, an electrode, or the like if an electrical contact is present and may be, for example, a wire or a cable.

The input capacitor 32 is connected between the positive-side input terminal 22 and the negative-side input terminal 24. Note that the input capacitor 32 may be provided on the outside of an input side of the power conversion device 10.

The switching circuit 34 is a full-bridge type switch. The switching circuit 34 generates a primary-side AC voltage between a first intermediate terminal 52 and a second intermediate terminal 54 by alternately and complementarily connecting the positive-side input terminal 22 and the negative-side input terminal 24 to each of the first intermediate terminal 52 and the second intermediate terminal 54. Note that each of the first intermediate terminal 52 and the second intermediate terminal 54 may not be provided with a pad, an electrode, or the like if an electrical contact is present and may be, for example, a wire or a cable.

The switching circuit 34 includes a first switch element 62, a second switch element 64, a third switch element 66, and a fourth switch element 68. Each of the first switch element 62, the second switch element 64, the third switch element 66, and the fourth switch element 68 is a semiconductor element that switches a power line to ON (conduction) or OFF (non-conduction) according to control from the controller 46. For example, each of the first switch element 62, the second switch element 64, the third switch element 66, and the fourth switch element 68 is a MOSFET (metal-oxide-semiconductor Field Effect Transistor). In the present embodiment, each of the first switch element 62, the second switch element 64, the third switch element 66, and the fourth switch element 68 is an N-type MOSFET configured by a Si semiconductor.

The first switch element 62 is connected between the positive-side input terminal 22 and the first intermediate terminal 52 and switches ON (conduction) and OFF (non-conduction) between the positive-side input terminal 22 and the first intermediate terminal 52. When the first switch element 62 is an N-type MOSFET, a drain thereof is connected to the positive-side input terminal 22 and a source thereof is connected to the first intermediate terminal 52. A Q1 signal, which is a switching signal, output from the controller 46 is applied to a gate of the first switch element 62 and the first switch element 62 is switched on or off by the Q1 signal.

The second switch element 64 is connected between the first intermediate terminal 52 and the negative-side input terminal 24 and switches the first intermediate terminal 52 and the negative-side input terminal 24 to ON (conduction) or OFF (non-conduction). When the second switch element 64 is an N-type MOSFET, a drain thereof is connected to the first intermediate terminal 52 and a source thereof is connected to the negative-side input terminal 24. A Q2 signal, which is a switching signal, output from the controller 46 is applied to a gate of the second switch element 64 and the second switch element 64 is switched on or off by the Q2 signal.

The third switch element 66 is connected between the positive-side input terminal 22 and the second intermediate terminal 54 and switches the positive-side input terminal 22 and the second intermediate terminal 54 to ON (conduction) or OFF (non-conduction). When the third switch element 66 is an N-type MOSFET, a drain thereof is connected to the positive-side input terminal 22 and a source thereof is connected to the second intermediate terminal 54. A Q3 signal, which is a switching signal, output from the controller 46 is applied to a gate of the third switch element 66 and the third switch element 66 is switched on or off by the Q3 signal.

The fourth switch element 68 is connected between the second intermediate terminal 54 and the negative-side input terminal 24 and switches the second intermediate terminal 54 and the negative-side input terminal 24 to ON (conduction) or OFF (non-conduction). When the fourth switch element 68 is an N-type MOSFET, a drain thereof is connected to the second intermediate terminal 54 and a source thereof is connected to the negative-side input terminal 24. A Q4 signal, which is a switching signal, output from the controller 46 is applied to a gate of the fourth switch element 68 and the fourth switch element 68 is switched on or off by the Q4 signal.

The resonance circuit 36 includes an inductor 72 and a capacitor 74. The inductor 72 may be incorporated on the inside of the transformer 38.

The transformer 38 includes a primary-side coil 76 and a secondary-side coil 78. The primary-side coil 76 and the secondary-side coil 78 are magnetically coupled.

The primary-side coil 76, the inductor 72, and the capacitor 74 are connected in series. The primary-side coil 76, the inductor 72, and the capacitor 74 connected in series are connected between the first intermediate terminal 52 and the second intermediate terminal 54. In the present embodiment, the inductor 72 included in the resonance circuit 36 is connected between the first intermediate terminal 52 and one terminal of the primary-side coil 76. The capacitor 74 included in the resonance circuit 36 is connected between the second intermediate terminal 54 and a terminal on a side of the primary-side coil 76 to which the inductor 72 is not connected. Note that the primary-side coil 76, the inductor 72, and the capacitor 74 may be arranged in any order if connected in series between the first intermediate terminal 52 and the second intermediate terminal 54.

The secondary-side coil 78 causes a voltage change in the secondary-side coil 78 according to a voltage change in the primary-side coil 76. Consequently, an AC voltage is applied between the first intermediate terminal 52 and the second intermediate terminal 54, whereby the transformer 38 generates a secondary-side AC voltage in the secondary-side coil 78.

The rectifier circuit 40 full-wave rectifies the secondary-side AC voltage output from the secondary-side coil 78. The rectifier circuit 40 outputs a rectified voltage obtained by full-wave rectifying the secondary-side AC voltage output from the secondary-side coil 78.

In the present embodiment, the rectifier circuit 40 performs full-wave rectification of a full-bridge system by a diode. More specifically, the rectifier circuit 40 includes a first diode 82, a second diode 84, a third diode 86, and a fourth diode 88. An anode of the first diode 82 is connected to one terminal of the secondary-side coil 78 and a cathode of the first diode 82 is connected to the positive-side output terminal 26. An anode of the second diode 84 is connected to the negative-side output terminal 28 and a cathode of the second diode 84 is connected to a terminal of the secondary-side coil 78 to which the first diode 82 is connected. An anode of the third diode 86 is connected to a terminal of the secondary-side coil 78 to which the first diode 82 is not connected and a cathode of the third diode 86 is connected to the positive-side output terminal 26. An anode of the fourth diode 88 is connected to the negative-side output terminal 28 and a cathode of the fourth diode 88 is connected to a terminal of the secondary-side coil 78 to which the third diode 86 is connected.

Note that the rectifier circuit 40 may be any circuit if the rectifier circuit 40 can rectify the secondary-side AC voltage output from the secondary-side coil 78.

The smoothing circuit 42 outputs a voltage obtained by smoothing a voltage output from the rectifier circuit 40 between the positive-side output terminal 26 and the negative-side output terminal 28 as an output voltage Vout. For example, the smoothing circuit 42 includes a smoothing capacitor connected between the positive-side output terminal 26 and the negative-side output terminal 28.

The detector 44 detects a voltage, an electric current, and temperature in the power conversion device 10. In the present embodiment, the detector 44 detects an input voltage Vin, an output voltage Vout, an output current Iout supplied from the positive-side output terminal 26 to the load, a primary-side current It1 flowing to the primary-side coil 76 of the transformer 38, and a circuit temperature T of the transformer 38. Here, the output current Iout may be detected by an electric current Io2 of the rectifier circuit 40. The circuit temperature T of the transformer 38 may be a temperature of a portion different from the transformer 38 if the temperature is equivalent to the circuit temperature T of the transformer 38. The detector 44 gives the detected input voltage Vin, the detected output voltage Vout, the detected output current Iout, the detected primary-side current It1, and the detected circuit temperature T to the controller 46.

The detector 44 detects the input voltage Vin and the output voltage Vout by, for example, measuring the input voltage Vin and the output voltage Vout with an AD converter. The detector 44 detects the output current Iout by, for example, current-voltage converting the output current Iout with a detection resistor connected in series to the load and measuring a converted voltage with the AD converter.

In addition, the detector 44 detects the primary-side current It1 using, for example, a current transformer connected in series to the inductor 72. In this case, a primary side of the current transformer is connected to the inductor 72 in series. The detector 44 full-wave rectifies a secondary current flowing to a secondary side of the current transformer with a diode bridge circuit and current-voltage converts the full-wave rectified secondary current with the detection resistor. The detector 44 detects the primary-side current It1 by measuring the converted voltage with an AD converter.

The controller 46 includes, for example, a CPU (Central Processing Unit), a ROM (Read Only Memory), and a RAM (Random Access Memory). The CPU executes a program, whereby the controller 46 operates. For example, the controller 46 generates a Q1 signal, a Q2 signal, a Q3 signal, and a Q4 signal in cooperation with a processor such as the CPU and a program (software) stored in the ROM or the like. The controller 46 may be an information processing device. Note that a function of the controller 46 is not limited to a function realized by software and may be a circuit including a logic circuit or the like or may be realized by a hardware configuration such as a dedicated circuit.

In the present embodiment, the controller 46 gives the Q1 signal to the gate of the first switch element 62 and gives the Q2 signal to the gate of the second switch element 64. The controller 46 gives the Q3 signal to the gate of the third switch element 66 and gives the Q4 signal to the gate of the fourth switch element 68. The controller 46 complementarily switches the first switch element 62 and the second switch element 64 with an operation frequency fc by controlling the Q1 signal and the Q2 signal. The controller 46 complementarily switches the third switch element 66 and the fourth switch element 68 with the operation frequency fc by controlling the Q3 signal and the Q4 signal.

The controller 46 switches each of the first switch element 62, the second switch element 64, the third switch element 66, and the fourth switch element 68 at a duty ratio of 50%. That is, the controller 46 sets an ON time and an OFF time in each of the first switch element 62, the second switch element 64, the third switch element 66, and the fourth switch element 68 to be the same.

Further, in the controller 46, a target value of the output current Iout or output power Pout supplied to the load is set in advance. Based on the output current Iout or the output current Iout and the output voltage Vout detected by the detector 44, the controller 46 controls the operation frequencies fc of the Q1 signal, the Q2 signal, the Q3 signal, and the Q4 signal to set the output current Iout or the output power Pout as target values. Specifically, when the output current Iout or the output power Pout is increased, the controller changes the operation frequency fc in a direction of reducing the operation frequency fc and, when the output current Iout or the output power Pout is reduced, the controller 46 changes the operation frequency fc in a direction of increasing the operation frequency fc.

Further, the controller 46 switches switching phases of the first switch element 62, the second switch element 64, the third switch element 66, and the fourth switch element 68 in the first mode and the second mode.

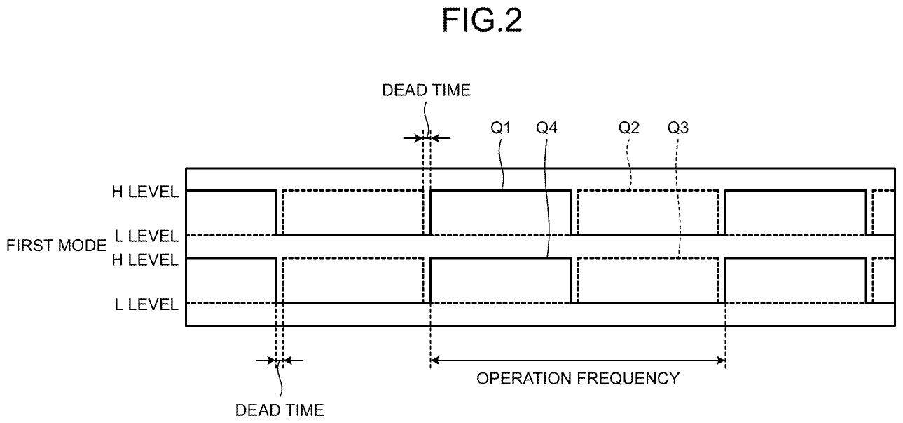

FIG. 2 is a diagram illustrating the Q1 signal, the Q2 signal, the Q3 signal, and the Q4 signal in the first mode.

In the present embodiment, the first switch element 62 is turned on (conductive) when the Q1 signal is at a high logic voltage (an H level) and is turned off (nonconductive) when the Q1 signal is at a low logic voltage (an L level). The second switch element 64 is turned on (conductive) when the Q2 signal is at a high logic voltage (an H level) and is turned off (nonconductive) when the Q2 signal is at a low logic voltage (an L level). The third switch element 66 is turned on (conductive) when the Q3 signal is at a high logic voltage (an H level) and is turned off (nonconductive) when the Q3 signal is at a low logic voltage (an L level). The fourth switch element 68 is turned on (conductive) when the Q4 signal is at a high logic voltage (an H level) and turned off (nonconductive) when the Q4 signal is at a low logic voltage (an L level).

The controller 46 complementarily switches the first switch element 62 and the second switch element 64. That is, when turning on the first switch element 62, the controller 46 turns off the second switch element 64. When turning on the second switch element 64, the controller 46 turns off the first switch element 62.

The controller 46 complementarily switches the third switch element 66 and the fourth switch element 68. That is, when turning on the third switch element 66, the controller 46 turns off the fourth switch element 68. When turning on the fourth switch element 68, the controller 46 turns off the third switch element 66.

Note that, in the present embodiment, the controller 46 provides a dead time when both of the first switch element 62 and the second switch element 64 are turned off at timing when a state in which the first switch element 62 is on and the second switch element 64 is off is switched to a state in which the first switch element 62 is off and the second switch element 64 is on and timing when a state in which the second switch element 64 is on and the first switch element 62 is off is switched to a state in which the second switch element 64 is off and the first switch element 62 is on. Consequently, the controller 46 can avoid both of the first switch element 62 and the second switch element 64 being simultaneously turned on because of a malfunction, timing deviation, or the like.

Similarly, the controller 46 provides a dead time when both of the fourth switch element 68 and the third switch element 66 are turned off at timing when a state in which the fourth switch element 68 is on and the third switch element 66 is off is switched to a state in which the fourth switch element 68 is off and the third switch element 66 is on and timing when a state in which the third switch element 66 is on and the fourth switch element 68 is off is switched to a state in which the third switch element 66 is off and the fourth switch element 68 is on. Consequently, the controller 46 can avoid both of the fourth switch element 68 and the third switch element 66 being simultaneously turned on because of a malfunction, timing deviation, or the like.

The dead time is a period that is sufficiently shorter than a switching cycle and has a small degree of influence on power conversion by the power conversion device 10.

The controller 46 switching-controls the first switch element 62, the second switch element 64, the third switch element 66, and the fourth switch element 68 in the first mode or the second mode.

In the first mode, the controller 46 simultaneously switches the first switch element 62 and the fourth switch element 68. That is, in the first mode, the controller 46 outputs the Q4 signal having the same phase and the same cycle as the phase and the cycle of the Q1 signal.

In the first mode, the controller 46 simultaneously switches the second switch element 64 and the third switch element 66. That is, in the first mode, the controller 46 outputs the Q3 signal having the same phase and the cycle as the phase and the cycle of the Q2 signal.

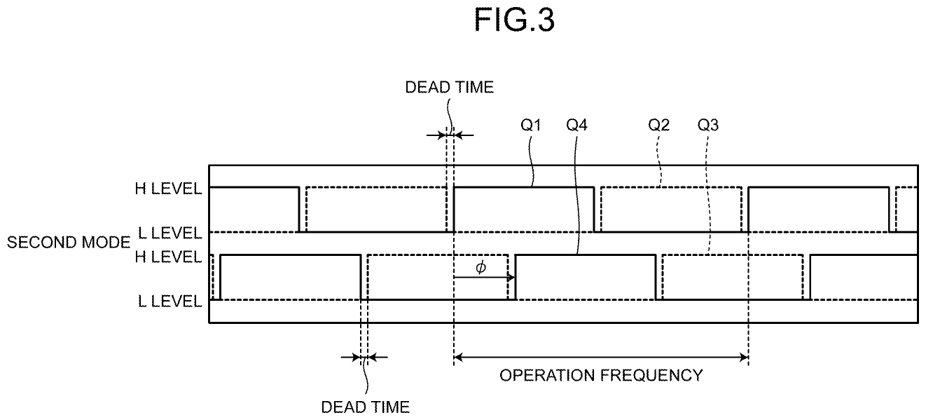

FIG. 3 is a diagram illustrating a Q1 signal, a Q2 signal, a Q3 signal, and a Q4 signal in the second mode.

In the second mode, the controller 46 switches the fourth switch element 68 with a phase of the fourth switch element 68 delayed by a predetermined first phase ϕ with respect to the first switch element 62. That is, in the second mode, the controller 46 outputs the Q4 signal having the same cycle as the cycle of the Q1 signal and a phase delayed from the phase of the Q1 signal by the first phase ϕ.

In the second mode, the controller 46 delays a switching phase of the third switch element 66 by the first phase ϕ with respect to the second switch element 64. That is, in the second mode, the controller 46 outputs the Q3 signal having the same cycle as the cycle of the Q2 signal and having a phase delayed from the phase of the Q2 signal by the first phase ϕ.

The first phase ϕ may be, for example, a preset phase in a range of 30 degrees to 90 degrees. In the present embodiment, the first phase ϕ is 75 degrees.

The controller 46 switches the first mode and the second mode according to the output voltage Vout detected by the detector 44. Note that the controller 46 may switch the first mode and the second mode according to the output current Iout, a dead time current Idet, which is the primary-side current It1, flowing to the inductor 72 in a dead time from when the fourth switch element 68 is turned off (nonconductive) until when the third switch element 66 is turned on (conductive), the input voltage Vin, or the circuit temperature T.

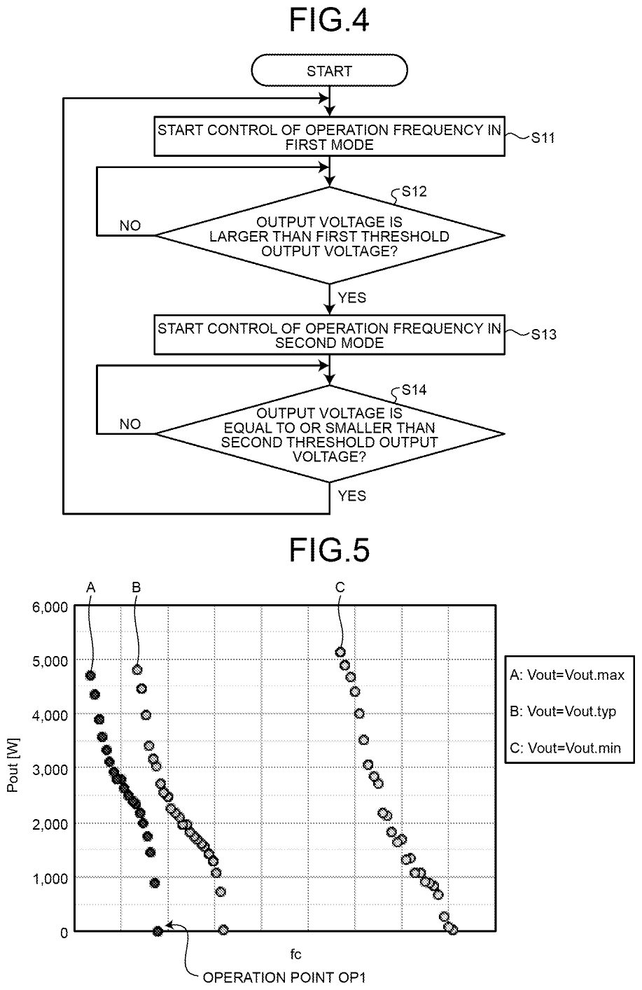

FIG. 4 is a flowchart illustrating switching processing for the first mode and the second mode by the controller 46.

The controller 46 switches the first mode and the second mode in the flow illustrated in FIG. 4. When starting power conversion operation, the controller 46 starts processing from S11.

In S11, the controller 46 starts control of the operation frequency fc in the first mode. That is, the controller 46 simultaneously switches the second switch element 64 and the fourth switch element 68. The controller 46 simultaneously switches the second switch element 64 and the third switch element 66. At the same time, the controller 46 controls the operation frequencies fc of the first switch element 62, the second switch element 64, the third switch element 66, and the fourth switch element 68 to set the output current Iout or the output power Pout to a preset target value.

Note that, in the first mode, the controller 46 sets a duty ratio of the switching of the first switch element 62 and the second switch element 64 to 50% and provides a dead time at switching timing. In the first mode, the controller 46 sets a duty ratio of the switching of the third switch element 66 and the fourth switch element 68 to 50% and provides a dead time at switching timing.

Subsequently, in S12, the controller 46 determines whether the output voltage Vout is larger than a predetermined first threshold output voltage. When the output voltage Vout is equal to or smaller than the first threshold output voltage (No in S12), the controller 46 stays on standby in S12 and continues the first mode. When the output voltage Vout is larger than the first threshold output voltage (Yes in S12), the controller 46 advances the processing to S13.

In S13, the controller 46 starts control of the operation frequency fc in the second mode. That is, the controller 46 delays the phase of the fourth switch element 68 by the first phase ϕ with respect to the first switch element 62 and switches the fourth switch element 68. The controller 46 delays the phase of the third switch element 66 by the first phase ϕ with respect to the second switch element 64 and switches the third switch element 66. At the same time, the controller 46 controls the operation frequencies fc of the first switch element 62, the second switch element 64, the third switch element 66, and the fourth switch element 68 to set the output current Iout or the output power Pout to a preset target value.

Note that, in the second mode, the controller 46 sets a duty ratio of the switching of the first switch element 62 and the second switch element 64 to 50% and provides a dead time at switching timing. In the second mode, the controller 46 sets a duty ratio of the switching of the third switch element 66 and the fourth switch element 68 to 50% and provides a dead time at switching timing.

When switching the first mode to the second mode, the controller 46 may increase the phase of the switching of the fourth switch element 68 with respect to the first switch element 62 and the phase of the switching of the third switch element 66 with respect to the second switch element 64 from 0 to the first phase ϕ according to the lapse of time. For example, the controller 46 may increase the phase by a predetermined angle at every predetermined second. Consequently, the controller 46 can eliminate steep fluctuations in the output current Iout and the output power Pout.

Subsequently, in S14, the controller 46 determines whether the output voltage Vout is equal to or smaller than a predetermined second threshold output voltage. When the output voltage Vout is larger than the second threshold output voltage (No in S14), the controller 46 stays on standby in S14 and continues the second mode. When the output voltage Vout is equal to or smaller than the second threshold output voltage (Yes in S14), the controller 46 returns the processing to S11. The controller 46 repeats the processing from S11.

Note that, when switching the second mode to the first mode, the controller 46 may reduce the phase of the switching of the fourth switch element 68 with respect to the first switch element 62 and the phase of the switching of the third switch element 66 with respect to the second switch element 64 from the first phase ϕ to 0 according to the lapse of time. For example, the controller 46 may reduce the phase by a predetermined angle at every predetermined second. Consequently, the controller 46 can eliminate steep fluctuations in the output current Iout and the output power Pout.

As explained above, in the first mode, when the output voltage Vout is larger than the first threshold output voltage, the controller 46 switches the first mode to the second mode. In the second mode, when the output voltage Vout is equal to or smaller than the second threshold output voltage, the controller 46 switches the second mode to the first mode.

For example, the second threshold output voltage is the same as the first threshold output voltage. Note that the second threshold output voltage may be smaller than the first threshold output voltage. Since the second threshold output voltage is smaller than the first threshold output voltage, the controller 46 can impart hysteresis to the switching of the first mode and the second mode.

Instead of the processing explained above, the controller 46 may switch the first mode and the second mode according to the output current Iout detected by the detector 44. In this case, in the first mode, when the output current Iout is smaller than a predetermined first threshold output current, the controller 46 switches the first mode to the second mode. In the second mode, when the output current Iout is equal to or larger than a predetermined second threshold output current, the controller 46 switches the second mode to the first mode.

For example, the second threshold output current is the same as the first threshold output current. Note that the second threshold output current may be larger than the first threshold output current. Since the second threshold output current is larger than the first threshold output current, the controller 46 can impart hysteresis to the switching of the first mode and the second mode.

The controller 46 may switch the first mode and the second mode according to the dead time current Idet, which is the primary-side current It1 flowing to the inductor 72 in a dead time from when the fourth switch element 68 is turned off (nonconductive) until when the third switch element 66 is turned on (conductive). The dead time current Idet is the primary-side current It1 flowing from the first intermediate terminal 52 in the direction of the primary-side coil 76 of the transformer 38 in the dead time. The controller 46 acquires, as the dead time current Idet, the primary-side current It1 detected by the detector 44 at the dead time.

In this case, in the first mode, when the dead time current Idet in the dead time from when the fourth switch element 68 is turned off (nonconductive) until when the third switch element 66 is turned on (conductive) is larger than a predetermined first threshold excitation current, the controller 46 switches the first mode to the second mode. In the second mode, when the dead time current Idet in the dead time from when the fourth switch element 68 is turned off (nonconductive) until when the third switch element 66 is turned on (conductive) is equal to or smaller than a predetermined second threshold excitation current, the controller 46 switches the second mode to the first mode.

For example, the second threshold excitation current is the same as the first threshold excitation current. The second threshold excitation current may be smaller than the first threshold excitation current. Since the second threshold excitation current is smaller than the first threshold excitation current, the controller 46 can impart hysteresis to switching of the first mode and the second mode.

The controller 46 may switch the first mode and the second mode according to the input voltage Vin detected by the detector 44. In this case, in the first mode, when the input voltage Vin is larger than a predetermined first threshold input voltage, the controller 46 switches the first mode to the second mode. In the second mode, when the input voltage Vin is equal to or smaller than a predetermined second threshold input voltage, the controller 46 switches the second mode to the first mode.

For example, the second threshold input voltage is the same as the first threshold input voltage. The second threshold input voltage may be smaller than the first threshold input voltage. Since the second threshold input voltage is smaller than the first threshold input voltage, the controller 46 can impart hysteresis to switching of the first mode and the second mode.

The controller 46 may switch the first mode and the second mode according to the circuit temperature T detected by the detector 44. In this case, in the first mode, when the circuit temperature T is larger than a predetermined first threshold temperature, the controller 46 switches the first mode to the second mode. In the second mode, the controller 46 switches the second mode to the first mode when the circuit temperature T is equal to or smaller than a predetermined second threshold temperature.

For example, the second threshold temperature is the same as the first threshold temperature. The second threshold temperature may be smaller than the first threshold temperature. Since the second threshold temperature is smaller than the first threshold temperature, the controller 46 can impart hysteresis to switching between the first mode and the second mode.

The controller 46 may switch the first mode and the second mode according to two or more parameters among the output voltage Vout, the output current Iout, the dead time current Idet, the input voltage Vin, and the circuit temperature T.

For example, in the first mode, when the output voltage Vout is larger than the predetermined first threshold output voltage and the output current Iout is smaller than the predetermined first threshold output current, the controller 46 may switch the first mode to the second mode. In the second mode, when the output voltage Vout is equal to or smaller than the predetermined second threshold output voltage or the output current Iout is equal to or larger than the predetermined second threshold output current, the controller 46 may switch the second mode to the first mode.

For example, in the first mode, when the output voltage Vout is larger than the predetermined first threshold output voltage, the output current Iout is smaller than the predetermined first threshold output current, and the dead time current Idet is larger than the predetermined first threshold excitation current, the controller 46 may switch the first mode to the second mode. In the second mode, when the output voltage Vout is equal to or smaller than the predetermined second threshold output voltage, the output current Iout is equal to or larger than the predetermined second threshold output current, or the dead time current Idet is equal to or smaller than the predetermined second threshold excitation current, the controller 46 may switch the second mode to the first mode.

As explained above, the controller 46 switches the first mode and the second mode according to at least one of the output voltage Vout, the output current Iout, the dead time current Idet in the dead time from when the fourth switch element 68 becomes nonconductive until when the third switch element 66 becomes conductive, the input voltage Vin, and the circuit temperature T.

Consequently, the power conversion device 10 can reduce an iron loss Pi in the transformer 38. Since the power conversion device 10 can reduce the iron loss Pi, heat generation in the transformer 38 can be reduced. Since the power conversion device 10 can reduce the heat generation in the transformer 38, a size of the transformer 38 can be reduced, a cooling structure can be reduced, and a circuit scale can be reduced. From the above, the power conversion device 10 can efficiently perform power conversion with simple control.

### Simulation

A reason why the power conversion device 10 can reduce the iron loss Pi by performing the control explained above is further explained below with reference to simulation results.

Note that, in the explanation of the simulation results, the conventional LLC resonance type DC-DC converter is referred to as conventional LLC converter. The conventional LLC converter is different from the power conversion device 10 according to the embodiment in that the Q1 signal and the Q4 signal are always controlled in the same phase relation and the Q2 signal and the Q3 signal are always controlled in the same phase relation. However, the explanation is made assuming that names of the elements for power conversion in the conventional LLC converter are the same as the names of the elements of the power conversion device 10. In the following simulation results, the first switch element 62, the second switch element 64, the third switch element 66, and the fourth switch element 68 are switched with a duty ratio fixed at 50%.

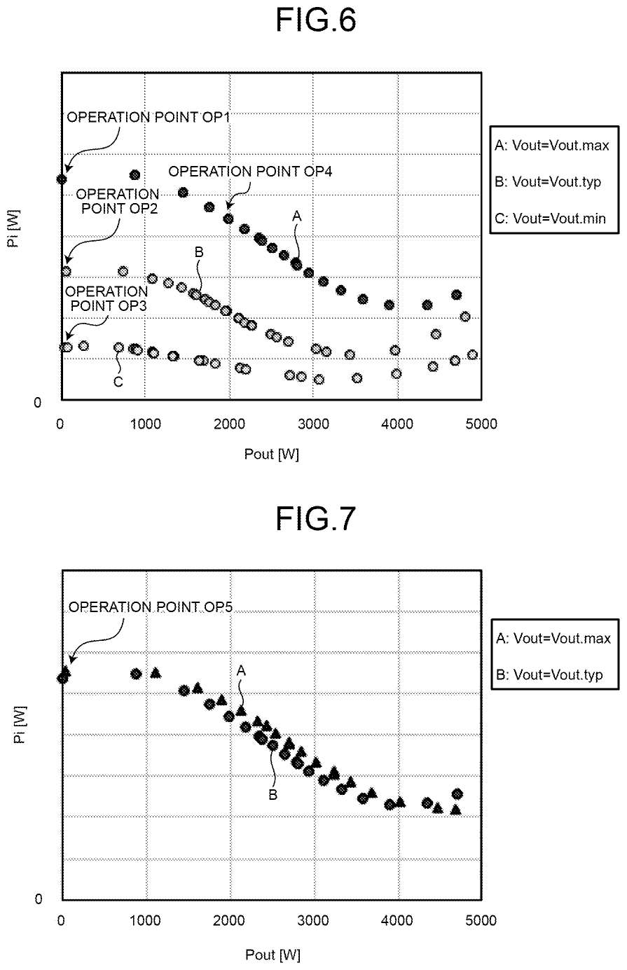

FIG. 5 is a diagram illustrating a simulation result of a characteristic of the output power Pout with respect to the operation frequency fc in the conventional LLC converter. FIG. 6 is a diagram illustrating a simulation result of the characteristic of the iron loss Pi with respect to the output power Pout in the case in which the input voltage Vin is fixed in the conventional LLC converter. In FIG. 5 and FIG. 6, A indicates a characteristic in the case in which the input voltage Vin is Vin.typ and the output voltage Vout is Vout.max, B indicates a characteristic in the case in which the input voltage Vin is Vin.typ and the output voltage Vout is Vout.typ, and C indicates a characteristic in the case in which the input voltage Vin is Vin.typ and the output voltage Vout is Vout.min. Note that Vin.min is a minimum value in a rated operation range of the input voltage Vin. Vin.typ is an approximately intermediate value between a maximum value and a minimum value in the rated operation range of the input voltage Vin and is a representative value. Vout.min is a minimum value in a rated operation range of the output voltage Vout. Vout.typ is an approximately intermediate value between a maximum value and a minimum value in the rated operation range of the output voltage Vout and is a representative value. Vout.max is a maximum value in the rated operation range of the output voltage Vout.

As illustrated in FIG. 5, when the output voltage Vout is fixed, the output power Pout increases as the operation frequency fc decreases. When the output power Pout is fixed, the operation frequency fc decreases as the output voltage Vout is larger. In the conventional LLC converter, a gain of power conversion increases by reducing fc. Therefore, fc has to be set smaller at the high output voltage Vout than at the low output voltage Vout.

As illustrated in FIG. 6, when the output power Pout is fixed, the iron loss Pi tends to increase as the output voltage Vout is larger. As illustrated in FIG. 6, the iron loss Pi tends to increase as a load is lighter.

FIG. 7 is a diagram illustrating a simulation result of a characteristic of the iron loss Pi with respect to the output power Pout at the time when the output voltage Vout is fixed in the conventional LLC converter. In FIG. 7, A indicates a characteristic in the case in which the input voltage Vin is Vin.max and the output voltage Vout is Vout.max and B indicates a characteristic in the case in which the input voltage Vin is Vin.typ and the output voltage Vout is Vout.max.

As illustrated in FIG. 7, when the output power Pout is fixed, the iron loss Pi tends to increase as the input voltage Vin is larger.

From the simulation results illustrated in FIG. 5, FIG. 6, and FIG. 7, in the conventional LLC converter, the iron loss Pi increases and heat generation increases when the output voltage Vout is large, the input voltage Vin is large, and the output power Pout is small. Therefore, when the conventional LLC converter is caused to operate under conditions that the output voltage Vout is large, the input voltage Vin is large, or the output power Pout is small, the conventional LLC converter has to include the transformer 38 having a large core size or include a cooling structure having a high cooling capability to normally operate even if the iron loss Pi occurs. Therefore, a circuit size or cost increase.

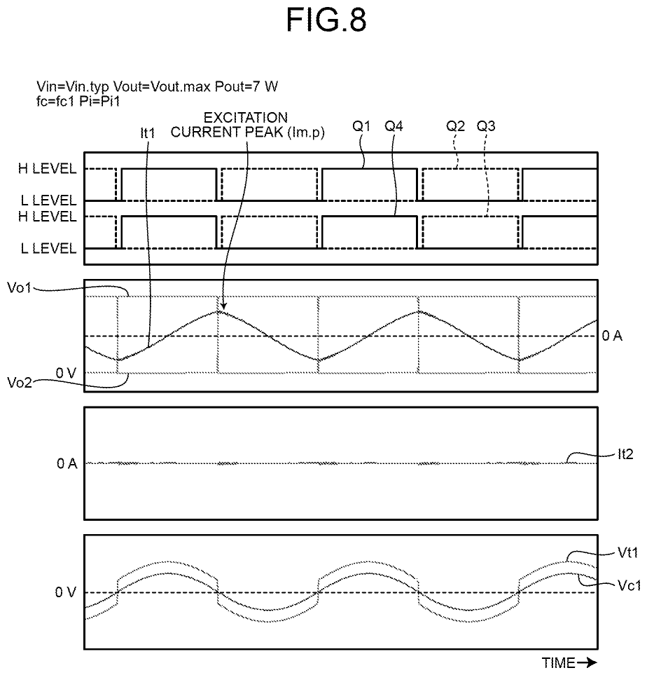

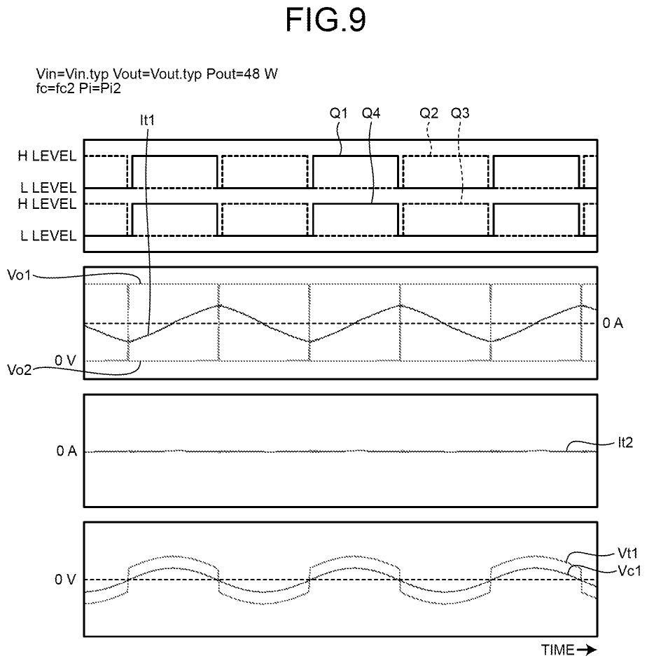

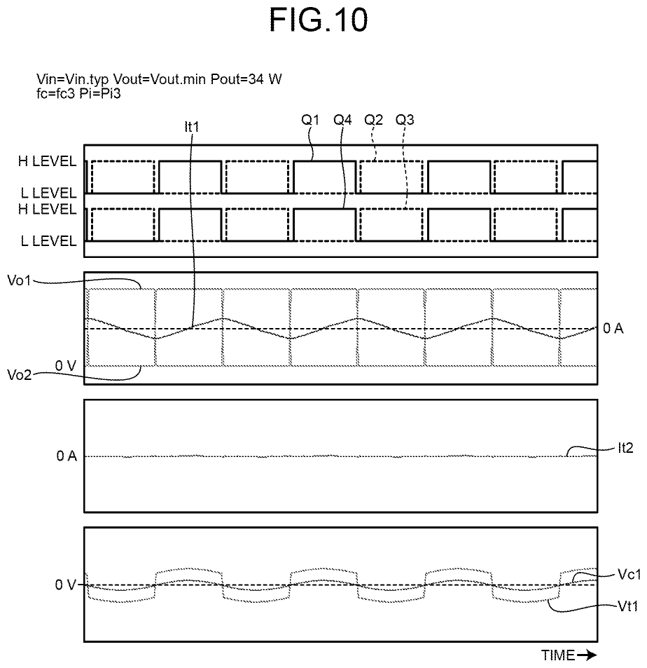

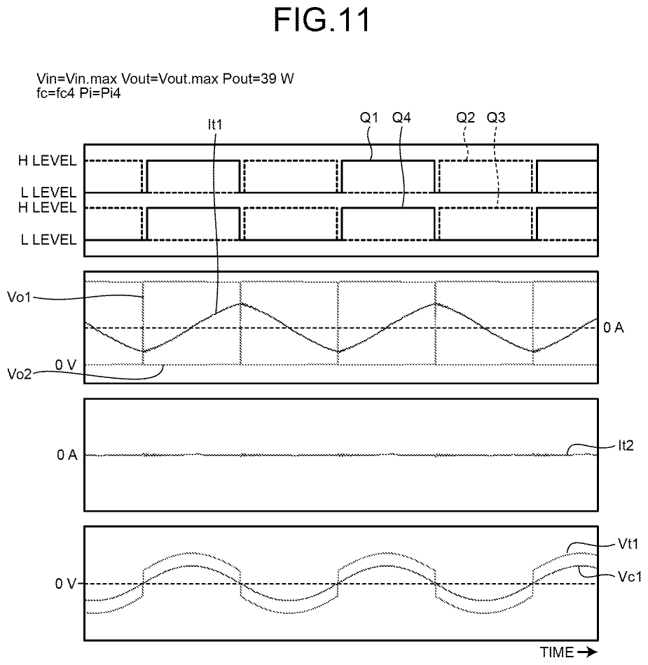

FIG. 8, FIG. 9, FIG. 10, and FIG. 11 are diagrams illustrating simulation waveforms at the time of no load in the conventional LLC converter. FIG. 8, FIG. 9, and FIG. 10 illustrate the Q1 signal, the Q2 signal, the Q3 signal, the Q4 signal, the primary-side currents It1 and It2, and Vo1, Vo2, Vc1, and Vt1. In FIG. 8 to FIG. 10, scaling is equal on the vertical axis and the horizontal axis.

It2 represents an electric current flowing to the secondary-side coil 78. Vo1 represents a voltage of the first intermediate terminal 52. Vo2 represents a voltage of the second intermediate terminal 54. Vc1 represents a voltage of the capacitor 74. Vt1 represents a primary-side voltage of the transformer 38 and is a voltage of the primary-side coil 76 and the inductor 72.

FIG. 8 illustrates waveforms in the case in which the input voltage Vin is Vin.typ, the output voltage Vout is Vout.max, the output power Pout is 7 W, the operation frequency fc is fc1, and the iron loss Pi is Pi1. The waveforms illustrated in FIG. 8 are waveforms at an operation point OP1 in FIG. 5 and FIG. 6.

FIG. 9 illustrates waveforms in the case in which the input voltage Vin is Vin.typ, the output voltage Vout is Vout.typ, the output power Pout is 48 W, the operation frequency fc is fc2, and the iron loss Pi is Pi2. The waveforms illustrated in FIG. 9 are waveforms at an operation point OP2 in FIG. 6.

FIG. 10 illustrates waveforms in the case in which the input voltage Vin is Vin.typ, the output voltage Vout is Vout.min, the output power Pout is 34 W, the operation frequency fc is fc3, and the iron loss Pi is Pi3. The waveforms illustrated in FIG. 10 are waveforms at an operation point OP3 in FIG. 6.

FIG. 11 illustrates waveforms in the case in which the input voltage Vin is Vin.max, the output voltage Vout is Vout.max, the output power Pout is 39 W, the operation frequency fc is fc4, and the iron loss Pi is Pi4. The waveforms illustrated in FIG. 11 are waveforms at the operation point OP5 in FIG. 7. Note that, in FIG. 11, scaling on the vertical axis and the horizontal axis is equal to the scaling in FIG. 8 to FIG. 10.

In general, the iron loss Pi increases as a VT product (which takes an absolute value), which is a time integral value of Vt1, which is a voltage of the primary-side coil 76 and the inductor 72 of the transformer 38, is larger. As illustrated in FIG. 8, FIG. 9, and FIG. 10, the VT product is the largest in FIG. 8 in which the output voltage Vout is Vout.max and the VT product is the smallest in FIG. 10 in which the output voltage Vout is Vout.min. When FIG. 8 and FIG. 11 are compared, it is seen that the output voltage Vout is larger in FIG. 11, although slightly.

The primary-side current It1 includes an excitation current Im for exciting the transformer 38. The excitation current Im is generated by resonance of the inductor 72 and the capacitor 74. A time waveform (Im (t)) of the excitation current Im is represented by a function of Expression (1).

$$Im ( t ) = \int ( V t 1 ( t ) / Lp ) dt \qquad ( 1 )$$

Note that t represents time. Lp represents L1+Lr. L1 is the inductance of the primary-side coil 76 of the transformer 38. Lr is the inductance of the inductor 72. J represents an integral sign. dt represents a very short time.

From Expression (1), a peak value Im.p of the excitation current Im increases as the VT product is larger. That is, when the peak value Im.p of the excitation current Im is large, the VT product increases.

Vt1, which is the primary-side voltage of the transformer 38, is represented by Expression (2).

$$V t 1 = V o 1 - V o 2 + V c 1 \qquad ( 2 )$$

When the first switch element 62 (then Q1 signal) is on and the fourth switch element 68 (the Q4 signal) is on and when the second switch element 64 (the Q2 signal) is off while the third switch element 66 (the Q3 signal) is off, Vt1=Vin+Vc1 is obtained. Therefore, in this case, the transformer 38 has to output a voltage larger than the output voltage Vout as the secondary-side voltage Vt2.

Therefore, Vc1 increases as the output voltage Vout is larger. As a result, Vt1, which is the primary-side voltage of the transformer 38, increases as the output voltage Vout is larger.

The operation frequency fc decreases as the output voltage Vout is larger. Therefore, an integration time of Expression (1) increases as the operation frequency fc is smaller. That is, the VT product increases as the output voltage Vout is larger. Accordingly, the iron loss Pi increases as the output voltage Vout is larger.

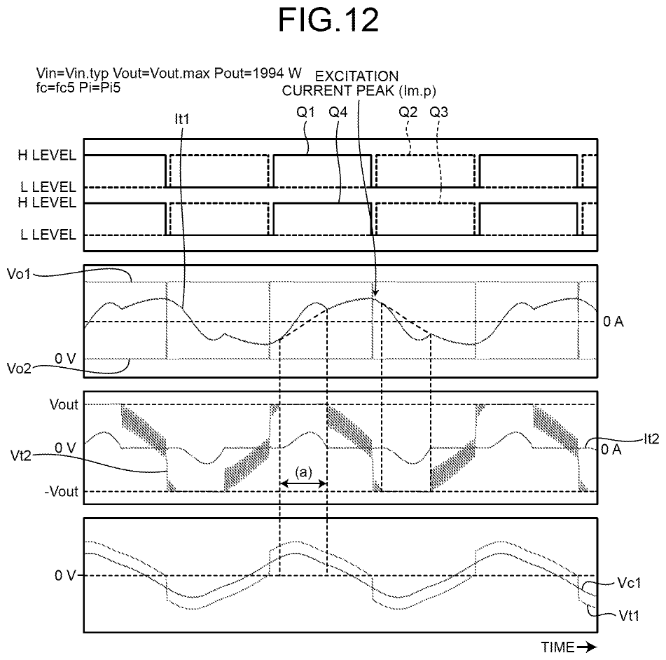

FIG. 12 is a diagram illustrating a simulation waveform at the time of load connection in the conventional LLC converter. FIG. 12 illustrates the Q1 signal, the Q2 signal, the Q3 signal, and the Q4 signal, the primary-side currents It1 and It2, and Vo1, Vo2, Vc1, Vt1, and Vt2. Vt2 represents a secondary-side voltage of the transformer 38 and is a voltage of the secondary-side coil 78. Note that, in FIG. 12, scaling on the vertical axis and the horizontal axis is equal to the scaling illustrated in FIG. 8 to FIG. 11.

FIG. 12 illustrates waveforms in the case in which the input voltage Vin is Vin.typ, the output voltage Vout is Vout.max, the output power Pout is 1994 W, the operation frequency fc is fc5, and the iron loss Pi is Pi5. The waveforms illustrated in FIG. 12 are waveforms at an operation point OP4 in FIG. 6.

As illustrated in a period (a) in FIG. 12, in a period in which Vt1 increases and the absolute value of Vt2 is larger than the output voltage Vout, It2, which is the electric current flowing to the secondary-side coil 78 of the transformer 38, is generated in a half-wave shape of a sine wave, that is, a resonance waveform shape by the inductor 72 and the capacitor 74.

Therefore, in the period (a), the primary-side current It1 has a waveform in which Im and It2 are superimposed. A portion indicated by a dotted line of It1 illustrated in FIG. 12 represents the excitation current Im.

In the period (a), when the excitation current Im is negative, the excitation current Im acts to increase Vc1, which is the voltage of the capacitor 74. On the other hand, It2 superimposed on the primary-side current It1 acts to reduce Vc1.

In the period (a), when It2 is larger than the excitation current Im, that is, when a solid line portion in It1 illustrated in FIG. 12 becomes positive, Vc1 decreases. As a result, the VT product is, for example, smaller than the VT product at the time of no load under the same conditions illustrated in FIG. 8.

Therefore, the iron loss Pi is smaller as It2 is larger. In other words, the iron loss Pi is larger as the output current Iout is smaller.

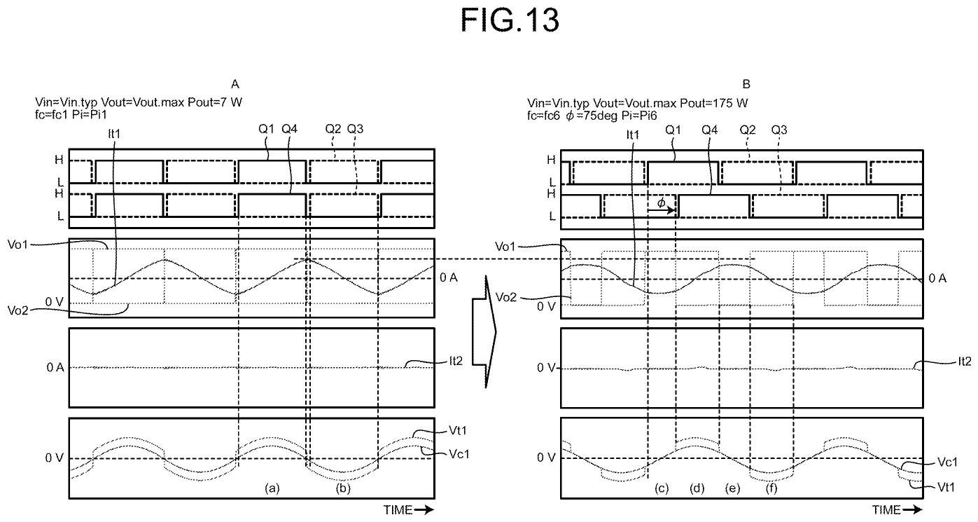

FIG. 13 is a diagram illustrating a simulation waveform at the time of no load in the power conversion device 10 according to the embodiment. FIG. 13 illustrates the Q1 signal, the Q2 signal, the Q3 signal, the Q4 signal, the primary-side currents It1 and It2, and Vo1, Vo2, Vc1, Vt1, and Vt2. Note that, in A and B of FIG. 13, scaling on the vertical axis and the horizontal axis is equal to the scaling illustrated in FIG. 8 to FIG. 12.

A in FIG. 13 illustrates a simulation waveform in the first mode, that is, in the case in which the Q1 signal and the Q4 signal are simultaneously switched and the Q2 signal and the Q3 signal are simultaneously switched. B in FIG. 13 illustrates a simulation waveform in the second mode, that is, in the case in which the phase of the Q4 signal is delayed by the first phase ϕ with respect to the Q1 signal and the phase of the Q3 signal is delayed by the first phase ϕ with respect to the Q2 signal.

Note that, in the following explanation, Expression (3) and Expression (4) are represented as follows.

$$d ( Im ( t ) ) / dt = V t 1 ( t ) / Lp \qquad ( 3 )$$

$$d ( V c 1 ( t ) ) / dt = - C 1 \times Im ( t ) \qquad ( 4 )$$

The operation of the power conversion device 10 in the first mode at the time of no load is as follows.

In a period (a) illustrated in A of FIG. 13, the Q1 signal and the Q4 signal are on, Vo1−Vo2=Vin, and Vt1=Vin+Vc1. Therefore, from Expression (3), in the period (a), the excitation current Im suddenly rises. From Expression (4), Vc1 and Vt1 increase in a period of Im(=It1)<0 in the period (a). From Expression (4), Vc1 and Vt1 decrease in a period of Im(=It1)>0 in the period (a).

In a period (b) illustrated in A of FIG. 13, the Q2 signal and the Q3 signal are on, Vo1−Vo2=−Vin, and Vt1=−Vin+Vc1. Therefore, from Expression (3), in the period (b), the excitation current Im suddenly falls. From Expression (4), Vc1 and Vt1 decrease in a period of Im(=It1)>0 in the period (b). From Expression (4), Vc1 and Vt1 increase in a period of Im(=It1)<0 in the period (b).

The operation of the power conversion device 10 in the second mode at the time of no load is as follows.

In a period (c) illustrated in B of FIG. 13, the Q1 signal and the Q3 signal are on, Vo1−Vo2=0, and Vt1=Vc1. Therefore, from Expression (3), the excitation current Im gently changes. The period (c) is Im(=It1)<0. Therefore, from Expression (4), Vc1 and Vt1 increase in the period (c).

In a period (d) illustrated in B of FIG. 13, the Q1 signal and the Q4 signal are on, Vo1−Vo2=Vin, and Vt1=Vin+Vc1. Therefore, from Expression (3), in the period (d), the excitation current Im suddenly rises. From Expression (4), Vc1 and Vt1 increase in a period of Im(=It1)<0 in the period (d). From Expression (4), Vc1 and Vt1 decrease in a period of Im(=It1)>0.

In a period (e) illustrated in B of FIG. 13, the Q2 signal and the Q4 signal are on, Vo1−Vo2=0, and Vt1=Vc1. Therefore, from Expression (3), the excitation current Im gently changes. The period (e) is Im(=It1)>0. Therefore, from Expression (4), Vc1 and Vt1 decrease in the period (e).

In a period (f) illustrated in B of FIG. 13, the Q2 signal and the Q3 signal are on, Vo1−Vo2=−Vin, and Vt1=−Vin+Vc1. Therefore, from Expression (3), in the period (f), the excitation current Im suddenly falls. From Expression (4), Vc1 and Vt1 decrease in a period of Im(=It1)>0 in the period (f). From Expression (4), Vc1 and Vt1 increase in a period Im (=It1)<0 in the period (f).

As explained above, in the period (c) and the period (e), the excitation current Im gently changes. Therefore, in the second mode, the power conversion device 10 can reduce a peak value of the excitation current Im. In the period (c) and the period (e), the power conversion device 10 is Vt1=Vc1. Therefore, in the second mode, since the input voltage Vin is not superimposed on Vt1, the power conversion device 10 can reduce the VT product. Consequently, in the second mode, the power conversion device 10 can reduce the iron loss Pi.

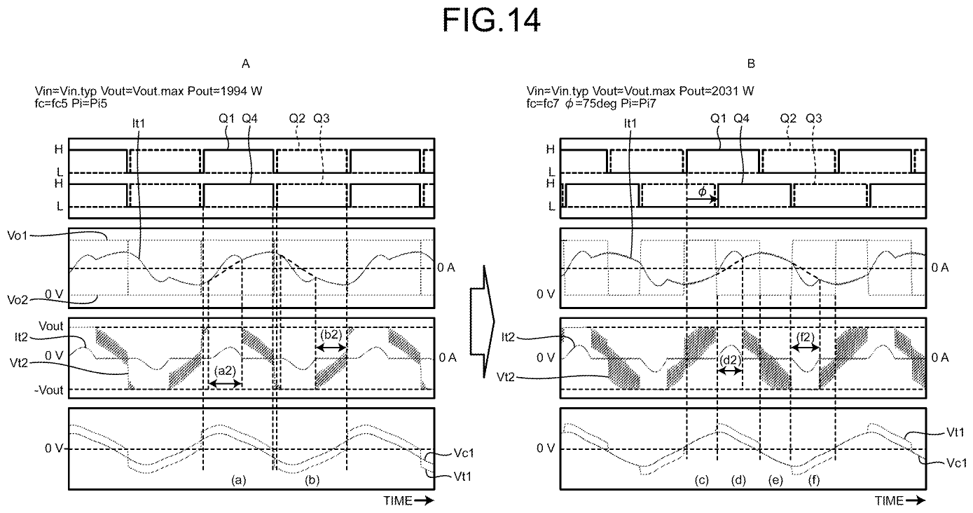

FIG. 14 is a diagram illustrating a simulation waveform at the time of load connection in the power conversion device 10. FIG. 14 illustrates the Q1 signal, the Q2 signal, the Q3 signal, the Q4 signal, the primary-side currents It1 and It2, and Vo1, Vo2, Vc1, Vt1, and Vt2. Note that, in A and B of FIG. 14, scaling on the vertical axis and the horizontal axis is equal to the scaling illustrated in FIG. 8 to FIG. 13.

A of FIG. 14 illustrates a simulation waveform in the first mode, that is, in the case in which the Q1 signal and the Q4 signal are simultaneously switched and the Q2 signal and the Q3 signal are simultaneously switched. B of FIG. 14 illustrates a simulation waveform in the second mode, that is, in the case in which the phase of the Q4 signal is delayed by the first phase ϕ with respect to the Q1 signal and the phase of the Q3 signal is delayed by the first phase with respect to the Q2 signal.

An operation of the power conversion device 10 in the first mode at the time of load connection is as follows.

In a period (a) illustrated in A of FIG. 14, the Q1 signal and the Q4 signal are on, Vo1−Vo2=Vin, and Vt1=Vin+Vc1. Therefore, from Expression (3), in the period (a), the excitation current Im suddenly rises.

From Expression (4), Vc1 and Vt1 increase in a period of It1<0 in the period (a). As illustrated in a period (a2), in a period in which Vt2, which is the voltage of the secondary-side coil 78 of the transformer 38, exceeds Vout, It2, which is the electric current of the secondary-side coil 78 of the transformer 38, is generated in a sine half-wave shape. At this time, It1 has a waveform in which It2 is superimposed on Im. Note that, in A of FIG. 14, a waveform indicated by a dotted line represents Im.

From Expression (4), in a period of It1>0 in the period (a), Vc1 and Vt1 decrease and It2 disappears.

In a period (b) illustrated in A of FIG. 14, the Q2 signal and the Q3 signal are on, Vo1−Vo2=−Vin, and Vt1=−Vin+Vc1. Therefore, from Expression (3), in the period (b), the excitation current Im suddenly falls.

From Expression (4), Vc1 and Vt1 increase in the negative direction in a period of It1>0 in the period (b). As illustrated in a period (b2), It2 is generated in a sine half-wave shape in a period in which Vt2 exceeds-Vout. At this time, It1 has a waveform in which It2 is superimposed on Im.

From Expression (4), in a period of It1<0 in the period (b), Vc1 and Vt1 increase in the positive direction and It2 disappears.

An operation of the power conversion device 10 in the second mode at the time of load connection is as follows.

In a period (c) illustrated in B of FIG. 14, the Q1 signal and the Q3 signal are on, Vo1−Vo2=0, and Vt1=Vc1. Therefore, from Expression (3), the excitation current Im gently changes. In the period (c), It1<0. Therefore, from Expression (4), Vc1 and Vt1 increase in the period (c).

In a period (d) illustrated in B of FIG. 14, the Q1 signal and the Q4 signal are on, Vo1−Vo2=Vin, and Vt1=Vin+Vc1. Therefore, from Expression (3), in the period (d), the excitation current Im suddenly rises. As illustrated in the period (d2), It2 is generated in a sine half-wave shape in a period in which Vt2 exceeds Vout. At this time, It1 has a waveform in which It2 is superimposed on Im.

From Expression (4), in a period of It1>0 in the period (d), Vc1 and Vt1 decrease and It2 disappears.

In a period (e) illustrated in B of FIG. 14, the Q2 signal and the Q4 signal are on, Vo1−Vo2=0, and Vt1=Vc1. Therefore, from Expression (3), the excitation current Im gently changes. In the period (e), It1>0. Therefore, from Expression (4), Vc1 and Vt1 decrease in the period (e).

In a period (f) illustrated in B of FIG. 14, the Q2 signal and the Q3 signal are on, Vo1−Vo2=−Vin, and Vt1=−Vin+Vc1. Therefore, from Expression (3), in the period (f), the excitation current Im suddenly falls. As illustrated in the period (f2), It2 is generated in a sine half-wave shape in a period in which Vt2 exceeds Vout. At this time, It1 has a waveform in which It2 is superimposed on Im.

From Expression (4), in a period of It1<0 in the period (f), Vc1 and Vt1 increase in the positive direction and It2 disappears.

As explained above, even if the load is connected, the excitation current Im gently changes in the period (c) and the period (e). Therefore, even if the load is connected, the power conversion device 10 can reduce the peak value of the excitation current Im in the second mode. In the period (c) and the period (e), the power conversion device 10 is Vt1=Vc1. Therefore, in the second mode, since the input voltage Vin is not superimposed on Vt1, the power conversion device 10 can reduce the VT product. Consequently, even if the load is connected, the power conversion device 10 can reduce the iron loss Pi in the second mode.

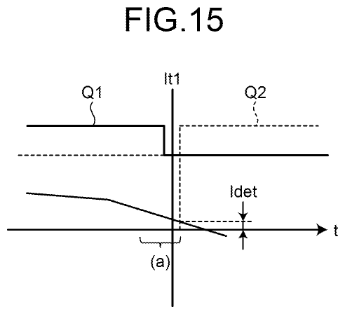

FIG. 15 is a diagram for explaining an Idet margin.

When a MOSFET is switched from off to on in a state in which a reverse current flows through a body diode, hard switching occurs to cause a large switching loss. Therefore, it is desirable that the power conversion device 10 perform switching control not to cause a large switching loss.

In the power conversion device 10 according to the present embodiment, the first switch element 62, the second switch element 64, the third switch element 66, and the fourth switch element 68 are N-type MOSFETs.

Therefore, the power conversion device 10 according to the present embodiment is caused to operate such that the primary-side current It1 flowing to the inductor 72 is 0 or more, that is, an electric current in a direction from the first intermediate terminal 52 toward the primary-side coil 76 is 0 or more in a dead time from when the first switch element 62 is turned off until when the second switch element 64 is turned on and a dead time from when the fourth switch element 68 is turned off until when the third switch element 66 is turned on. At the same time, the power conversion device 10 is caused to operate such that the primary-side current It1 is 0 or less in a dead time from when the second switch element 64 is turned off until when the first switch element 62 is turned on and a dead time from when the third switch element 66 is turned off until when the fourth switch element 68 is turned off.

However, in the power conversion device 10, even under a condition that hard switching does not occur in design, it is likely that hard switching occurs in actual operation because of noise, timing deviation, or the like. Therefore, it is desirable that the power conversion device 10 operates to secure an Idet margin having sufficient magnitude and not to cause hard switching even if noise, timing deviation, or the like occurs. The Idet margin is the magnitude of the primary-side current It1 in design at the dead time. For example, the Idet margin may be the magnitude of the primary current It1 in design at end timing of the dead time or may be the magnitude of the primary-side current It1 at any timing in the dead time as in the period (a) in the figure. For example, the Idet margin may be the magnitude of the primary-side current It1 at any timing before the dead time if the magnitude is in a range having correlation with the primary-side current It1 in design in the dead time.

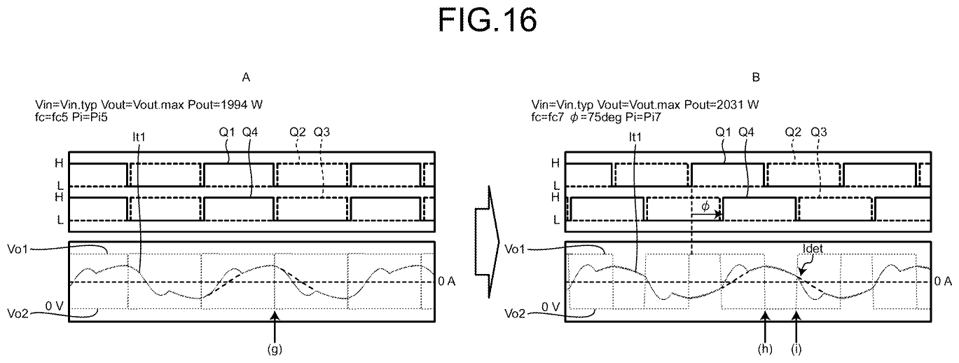

FIG. 16 is a diagram illustrating a simulation waveform at the time of load connection in the power conversion device 10. FIG. 16 illustrates the Q1 signal, the Q2 signal, the Q3 signal, the Q4 signal, the primary-side currents It1, and Vo1 and Vo2. Note that, in A and B of FIG. 16, scaling on the vertical axis and the horizontal axis is equal to the scaling illustrated in FIG. 8 to FIG. 14.

A of FIG. 16 illustrates a simulation waveform of the first mode. B of FIG. 16 illustrates a simulation waveform of the second mode.

As illustrated in A of FIG. 16, in the first mode, It1 in a dead time from when the first switch element 62 is turned off until when the second switch element 64 is turned on and a dead time from when the fourth switch element 68 is turned off until when the third switch element 66 is turned on is a nearly peak value on the positive side. In the first mode, It1 in a dead time from when the second switch element 64 is turned off until when the first switch element 62 is turned on and a dead time from when the third switch element 66 is turned off until when the fourth switch element 68 is turned off is a nearly peak value on the negative side.

Therefore, in the first mode, the power conversion device 10 secures an Idet margin having sufficient magnitude.

On the other hand, as illustrated in B of FIG. 16, in the second mode, It1 in a dead time from when the fourth switch element 68 is turned off until when the third switch element 66 is turned on is delayed from peak timing on the positive side and has a smaller absolute value than the peak value on the positive side. In the second mode, It1 in a dead time from when the third switch element 66 is turned off until when the fourth switch element 68 is turned on is delayed in peak timing on the negative side and has an absolute value smaller than the peak value on the negative side.

That is, when the power conversion device 10 is caused to operate in the second mode, the Idet margin decreases.

Therefore, the power conversion device 10 is caused to operate in the second mode while securing at least the Idet margin under a condition that the iron loss Pi increases. Alternatively, the power conversion device 10 is caused to operate in the second mode under a condition in which the Idet margin can be secured. The power conversion device 10 is caused to operate in the first mode under a condition that the Idet margin cannot be secured or under a condition that the iron loss Pi does not increase.

More specifically, for example, when the output voltage Vout is larger than a predetermined first threshold output voltage, the power conversion device 10 switches the first mode to the second mode. When the output voltage Vout is equal to or smaller than a predetermined second threshold output voltage, the power conversion device 10 switches the second mode to the first mode.

Consequently, the power conversion device 10 can be caused to operate in the second mode to reduce the iron loss Pi when the output voltage Vout, which is one of conditions that the iron loss Pi increases, is large. On the other hand, when the output voltage Vout is small and the iron loss Pi does not increase, the power conversion device 10 can be caused to operate in the first mode to reliably secure the Idet margin and operate reliably not to generate a switching loss.

For example, when the output current Iout is smaller than a predetermined first threshold output current, the power conversion device 10 switches the first mode to the second mode. When the output current Iout is equal to or larger than a predetermined second threshold output current, the power conversion device 10 switches the second mode to the first mode.

Consequently, when the output current Iout, which is one of the conditions that the iron loss Pi increases, is small, the power conversion device 10 can be caused to operate in the second mode to reduce the iron loss Pi. On the other hand, when the output current Iout is large and the iron loss Pi does not increase, the power conversion device 10 can be caused to operate in the first mode to reliably secure the Idet margin and operate reliably not to generate a switching loss.

For example, when the dead time current Idet in a dead time from when the fourth switch element 68 is turned off (nonconductive) until when the third switch element 66 is turned on (conductive) is larger than a predetermined first threshold excitation current, the power conversion device 10 switches the first mode to the second mode. When the dead time current Idet in a dead time from when the fourth switch element 68 is turned off (nonconductive) until when the third switch element 66 is turned on (conductive) is equal to or smaller than a predetermined second threshold excitation current, the power conversion device 10 switches the second mode to the first mode.

Consequently, when the Idet margin can be reliably secured, the power conversion device 10 can be caused to operate in the second mode to reduce the iron loss Pi. On the other hand, when the Idet margin cannot be secured in the second mode, the power conversion device 10 can be caused to operate in the first mode to reliably secure the Idet margin and operate reliably not to cause a switching loss.

For example, when the input voltage Vin is larger than the predetermined first threshold input voltage, the power conversion device 10 switches the first mode to the second mode. When the input voltage Vin is equal to or smaller than the predetermined second threshold input voltage, the power conversion device 10 switches the second mode to the first mode.

Consequently, when the input voltage Vin, which is one of the conditions that the iron loss Pi increases, is large, the power conversion device 10 can be caused to operate in the second mode to reduce the iron loss Pi. On the other hand, when the input voltage Vin is small and the iron loss Pi does not increase, the power conversion device 10 can be caused to operate in the first mode to reliably secure the Idet margin and operate reliably not to cause a switching loss.

For example, when the circuit temperature T is larger than the predetermined first threshold temperature, the power conversion device 10 switches the first mode to the second mode. When the circuit temperature T is equal to or smaller than the predetermined second threshold temperature, the power conversion device 10 switches the second mode to the first mode.

Consequently, when the circuit temperature T, which is one of the conditions that the iron loss Pi increases, is high, the power conversion device 10 can be caused to operate in the second mode to reduce the iron loss Pi. On the other hand, when the circuit temperature T is small and the iron loss Pi does not increase, the power conversion device 10 can be caused to operate in the first mode to reliably secure the Idet margin and operate reliably not to cause a switching loss.

Note that, when the Idet margin cannot be secured and the switching is performed, for example, in the case of Idet<0 at timing of (g) in A of FIG. 16, since It1<0, an electric current flows in a direction from the second intermediate terminal 54 toward the primary-side coil 76. Therefore, in such a case, an electric current flows via the body diode of the fourth switch element 68 and Vo2=0. Thereafter, when the third switch element 66 is turned on, since Vo2 rises to Vin, in the third switch element 66, hard switching occurs to cause a switching loss. In the fourth switch element 68, the third switch element 66 is turned on from a state in which an electric current is flowing to the body diode, whereby a drain voltage is raised. In general, recovery characteristics of a body diode of a high withstand voltage Si-based semiconductor are poor. When the drain voltage is raised in the state where an electric current is flowing to the body diode, a recovery current is generated and a large loss occurs. In order to avoid this, there is a case in which a MOSFET configured by an SiC semiconductor having good recovery characteristics is used for the first switch element 62, the second switch element 64, the third switch element 66, and the fourth switch element 68. In the present embodiment, when the power conversion device 10 is caused to operate in the second mode, the Idet margin is smaller in the third switch element 66 and the fourth switch element 68 than in the first switch element 62 and the second switch element 64 as at timing (h) and timing (i) in B of FIG. 16. Therefore, a MOSFET or the like configured by an SiC semiconductor having good recovery characteristics of a body diode can be used for only the third switch element 66 and the fourth switch element 68 and a MOSFET configured by an inexpensive Si semiconductor having poor recovery characteristics can be used for the first switch element 62 and the second switch element 64. Consequently, the power conversion device 10 can be configured by a more inexpensive device.

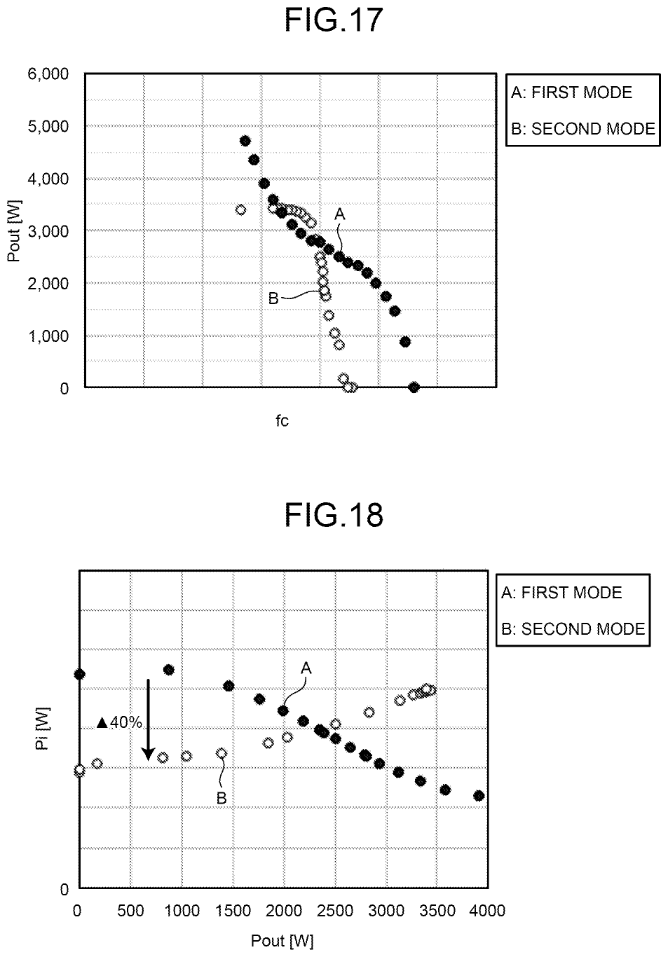

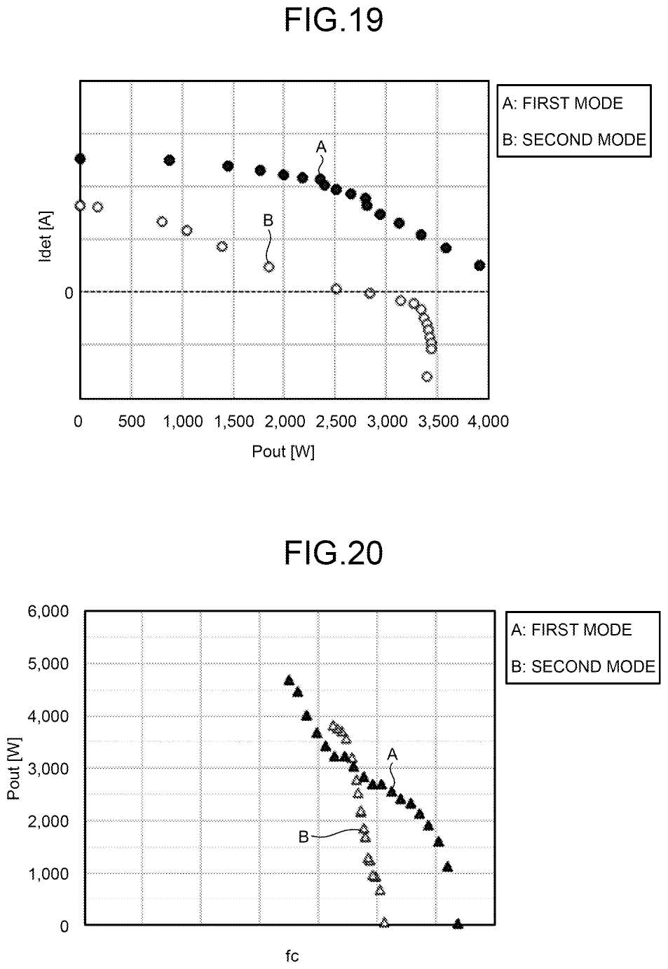

FIG. 17, FIG. 18, and FIG. 19 are diagrams illustrating simulation results in the case in which the power conversion device 10 operated under a first condition in which the input voltage Vin is Vin.typ and the output voltage Vout is Vout.max. FIG. 17 is a diagram illustrating the output power Pout with respect to the operation frequency fc. FIG. 18 is a diagram illustrating the iron loss Pi with respect to the output power Pout. FIG. 19 is a diagram illustrating the Idet margin with respect to the output power Pout. A indicates a result of the first mode and B indicates a result of the second mode.

As illustrated in FIG. 17, under the first condition, maximum output power of the power conversion device 10 is lower when the power conversion device 10 operates in the second mode than when operating in the first mode. However, under the first condition, since a curve of the output power Pout with respect to the operation frequency fc changes to be lower to the right in the second mode as well, the power conversion device 10 is capable of controlling the output power Pout by changing the operation frequency fc.

As illustrated in FIG. 18, under the first condition, when the output power Pout is 2000 W or less, the power conversion device 10 can reduce the iron loss Pi by operating in the second mode. The power conversion device 10 can reduce the iron loss Pi by approximately 40% at most by operating in the second mode.

As illustrated in FIG. 19, under the first condition, when the output power Pout is 2500 W or less, the power conversion device 10 can secure the Idet margin in the second mode as well.

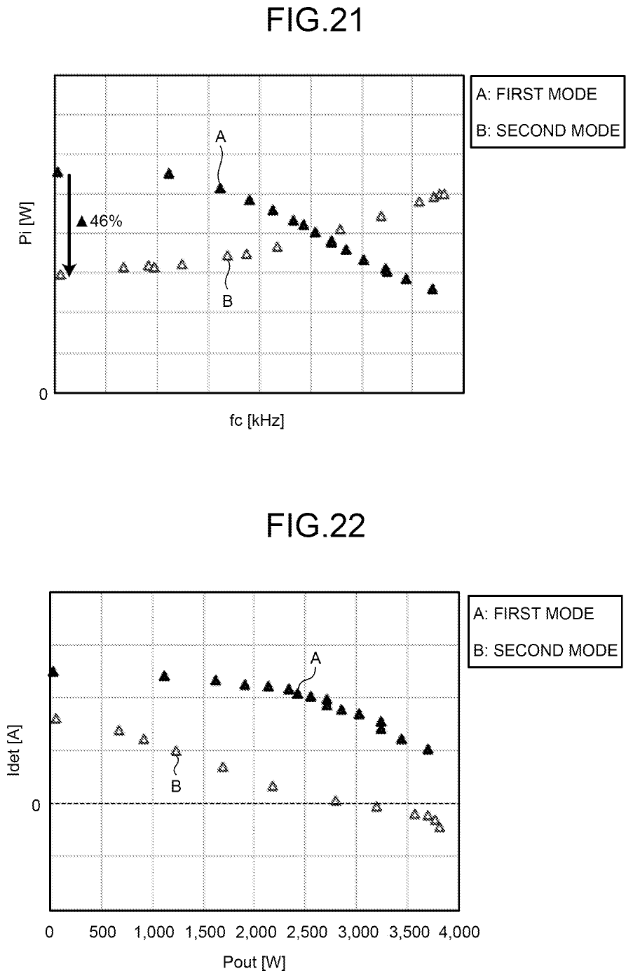

FIG. 20, FIG. 21, and FIG. 22 are diagrams illustrating simulation results in the case in which the power conversion device 10 operated under a second condition in which the input voltage Vin is Vin.max and the output voltage Vout is Vout.max. FIG. 20 is a diagram illustrating the output power Pout with respect to the operation frequency fc. FIG. 21 is a diagram illustrating the iron loss Pi with respect to the output power Pout. FIG. 22 is a diagram illustrating the Idet margin with respect to the output power Pout. A indicates a result of the first mode and B indicates a result of the second mode.

As illustrated in FIG. 20, under the second condition, maximum output power of the power conversion device 10 is lower when the power conversion device 10 operates in the second mode than when operating in the first mode. However, under the second condition, since a curve of the output power Pout with respect to the operation frequency fc changes to be lower to the right in the second mode as well, the power conversion device 10 is capable of controlling the output power Pout by changing the operation frequency fc.

As illustrated in FIG. 21, under the second condition, when the output power Pout is 2500 W or less, the power conversion device 10 can reduce the iron loss Pi by operating in the second mode. The power conversion device 10 can reduce the iron loss Pi by approximately 40% at most by operating in the second mode.

As illustrated in FIG. 22, under the second condition, when the output power Pout is 2500 W or less, the power conversion device 10 can secure the Idet margin in the second mode as well.

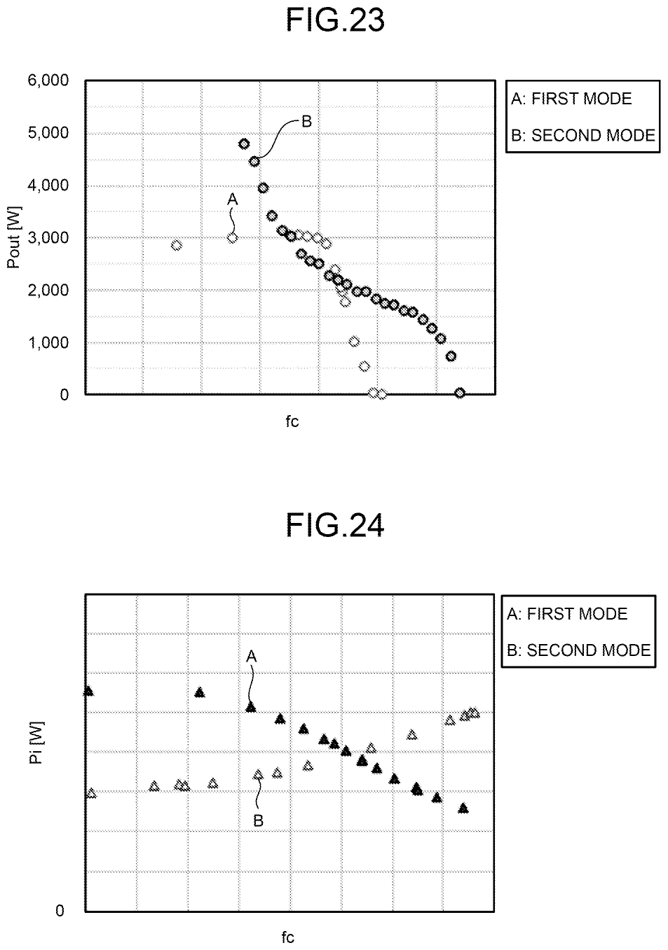

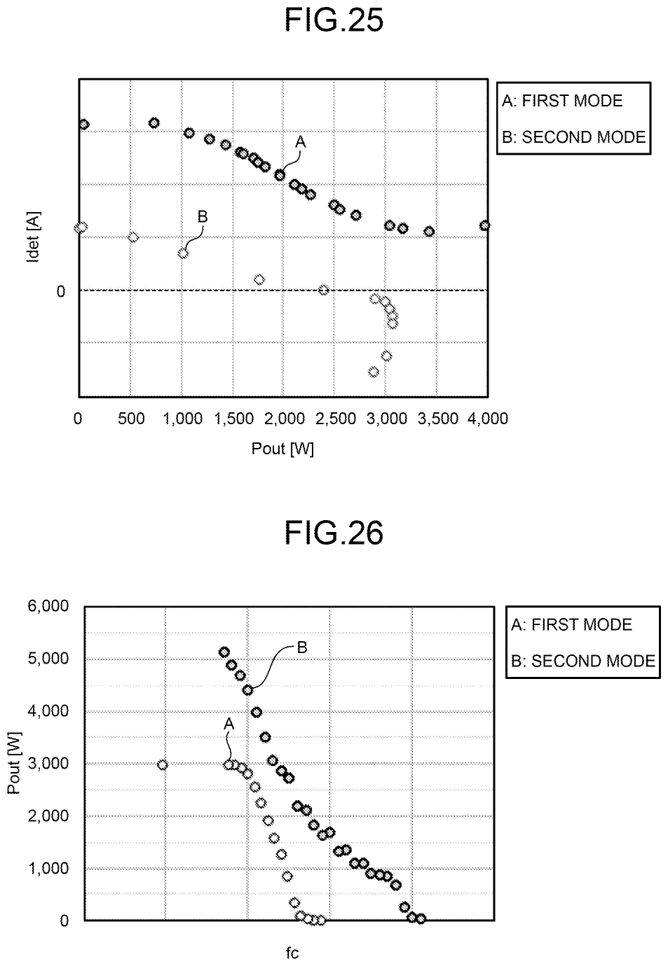

FIG. 23, FIG. 24, and FIG. 25 are diagrams illustrating simulation results in the case in which the power conversion device 10 operated under a third condition in which the input voltage Vin is Vin.typ and the output voltage Vout is Vout.typ. FIG. 23 is a diagram illustrating the output power Pout with respect to the operation frequency fc. FIG. 24 is a diagram illustrating the iron loss Pi with respect to the output power Pout. FIG. 25 is a diagram illustrating the Idet margin with respect to the output power Pout. A indicates a result of the first mode and B indicates a result of the second mode.

As illustrated in FIG. 23, under the third condition, maximum output power of the power conversion device 10 is lower when the power conversion device 10 operates in the second mode than when operating in the first mode. However, under the third condition, since a curve of the output power Pout with respect to the operation frequency fc changes to be lower to the right in the second mode as well, the power conversion device 10 is capable of controlling the output power Pout by changing the operation frequency fc.

As illustrated in FIG. 24, under the third condition, when the output power Pout is 2000 W or less, the power conversion device 10 can reduce the iron loss Pi by operating in the second mode. The power conversion device 10 can reduce the iron loss Pi by approximately 53% at most by operating in the second mode.

As illustrated in FIG. 25, under the third condition, when the output power Pout is 2000 W or less, the power conversion device 10 can secure the Idet margin in the second mode as well.

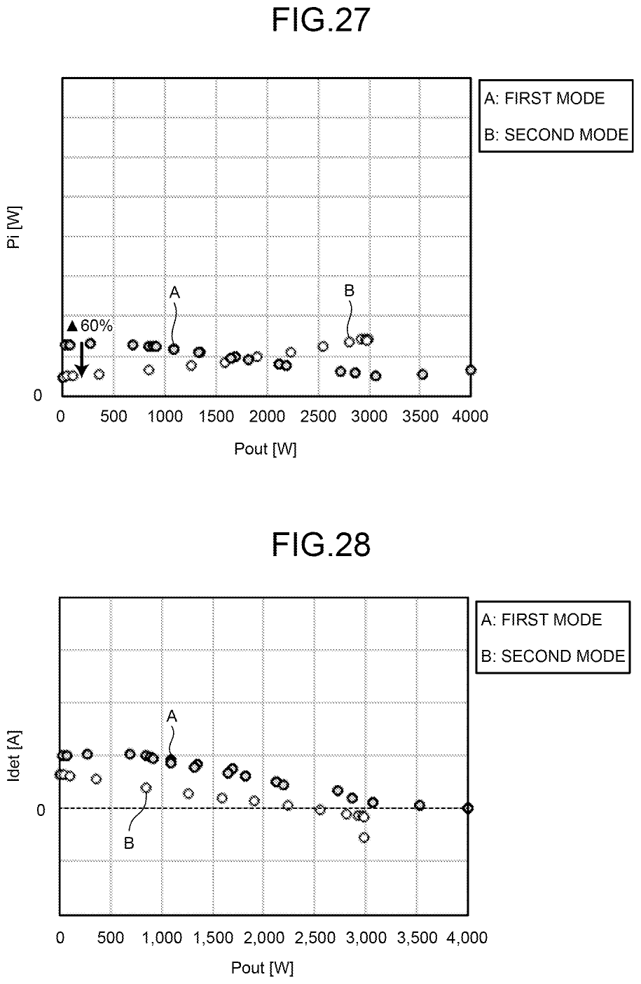

FIG. 26, FIG. 27, and FIG. 28 are diagrams illustrating simulation results in the case in which the power conversion device 10 operated under a fourth condition in which the input voltage Vin is Vin.typ and the output voltage Vout is Vout.min. FIG. 26 is a diagram illustrating the output power Pout with respect to the operation frequency fc. FIG. 27 is a diagram illustrating the iron loss Pi with respect to the output power Pout. FIG. 28 is a diagram illustrating the Idet margin with respect to the output power Pout. A indicates a result of the first mode and B indicates a result of the second mode.

As illustrated in FIG. 26, under the fourth condition, maximum output power of the power conversion device 10 is lower when the power conversion device 10 operates in the second mode than when operating in the first mode. However, under the fourth condition, since a curve of the output power Pout with respect to the operation frequency fc also changes to be lower to the right in the second mode, the power conversion device 10 is capable of controlling the output power Pout by changing the operation frequency fc.

As illustrated in FIG. 27, under the fourth condition, when the output power Pout is 1500 W or less, the power conversion device 10 can reduce the iron loss Pi by operating in the second mode. The power conversion device 10 can reduce the iron loss Pi by approximately 60% at most by operating in the second mode.

As illustrated in FIG. 28, under the fourth condition, when the output power Pout is 2000 W or less, the power conversion device 10 can secure the Idet margin in the second mode as well.

However, under the fourth condition, the absolute value of the iron loss Pi is small and the Idet margin in the second mode is also small in the entire range of the output power Pout. Therefore, under the fourth condition, the power conversion device 10 is preferably caused to operate in the first mode rather than being caused to operate in the second mode. Therefore, for example, when the output voltage Vout exceeds a threshold voltage higher than Vout.typ of the fourth condition, the power conversion device 10 is preferably caused to operate by being switched the first mode to the second mode.

### Modifications

Modifications of the switching control in the controller 46 are explained below. Note that, in explaining the following modifications, the same processing as the processing explained in the flowchart of FIG. 4 are denoted by the same step numbers and detailed explanation thereof is omitted except for differences.

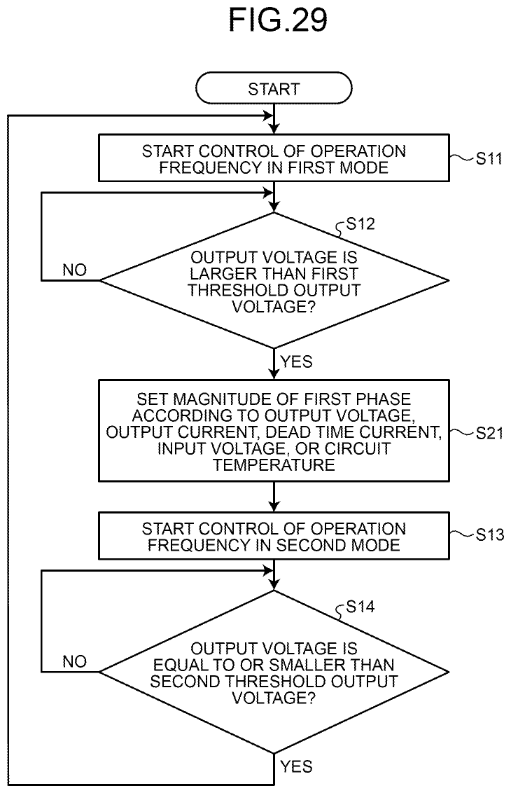

FIG. 29 is a flowchart illustrating processing of the controller 46 in a first modification.

In the first mode, when the output voltage Vout is larger than the first threshold output voltage (Yes in S12), the controller 46 advances the processing to S21.

In S21, the controller 46 sets the magnitude of the first phase ϕ according to the output voltage Vout, the output current Iout, the input voltage Vin, or the circuit temperature T. The controller 46 retains, for example, a table indicating a correspondence relation between the output voltage Vout, the output current Iout, the input voltage Vin, or the circuit temperature T and the first phase ϕ and sets the magnitude of the first phase ϕ with reference to the table. Following S21, the controller 46 advances the processing to S13.

In S13, the controller 46 starts control of the operation frequency fc in the second mode. That is, the controller 46 delays the phase of the fourth switch element 68 with respect to the first switch element 62 by the first phase ϕ having the magnitude set in S21. The controller 46 delays the phase of the third switch element 66 with respect to the second switch element 64 by the first phase ϕ having the magnitude set in S21. Then, the controller 46 controls the operation frequency fc of the first switch element 62, the second switch element 64, the third switch element 66, and the fourth switch element 68 such that the output current Iout or the output power Pout is set to a preset target value.

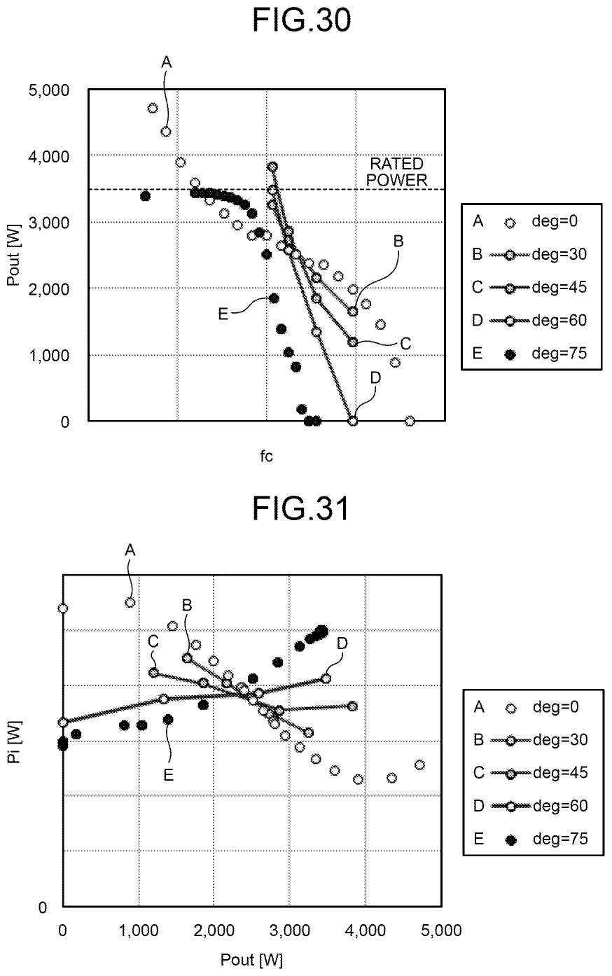

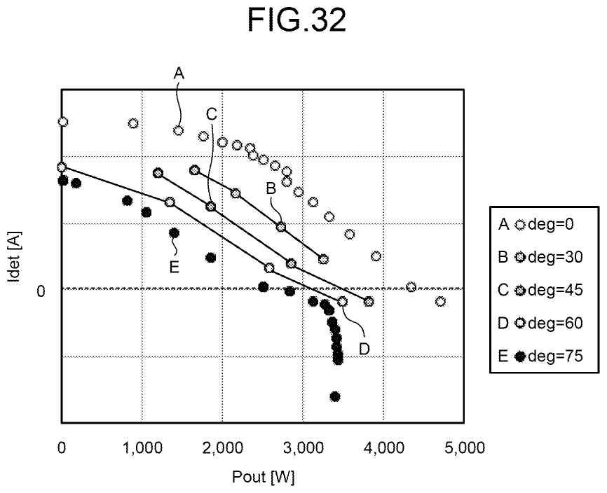

FIG. 30 is a diagram illustrating a characteristic of the output power Pout with respect to the operation frequency fc in the case in which the magnitude of the phase is changed. FIG. 31 is a diagram illustrating a characteristic of the iron loss Pi with respect to the output power Pout in the case in which the magnitude of the phase is changed. FIG. 32 is a diagram illustrating a characteristic of the Idet margin with respect to the output power Pout in the case in which the magnitude of the phase is changed.

Note that A indicates a characteristic of the first mode (deg=0). B indicates a characteristic that the first phase ϕ is 30 degrees (deg=30) in the second mode. C indicates a characteristic that the first phase ϕ is 45 degrees (deg=45) in the second mode. D indicates a characteristic that the first phase ϕ is 60 degrees (deg=60) in the second mode. E indicates a characteristic that the first phase ϕ is 75 degrees (deg=75) in the second mode.

As illustrated in FIG. 30, irrespective of which of 0 to 75 degrees the first phase ϕ is, a curve of the output power Pout with respect to the operation frequency fc changes to be lower to the right. The power conversion device 10 is capable of controlling the output power Pout by changing the operation frequency fc irrespective of which of 0 to 75 degrees the first phase ϕ is.

As illustrated in FIG. 31, the iron loss Pi in a region of 2500 W or less decreases as the first phase ϕ is larger. The iron loss Pi is substantially the same in the vicinity of the output power Pout of 2500 W irrespective of which of 0 to 75 degrees the first phase ϕ is.

As illustrated in FIG. 32, the Idet margin decreases as the first phase ϕ is larger. When the first phase ϕ is 75 degrees, the Idet margin is nearly 0 at a point where the iron loss Pi is the same regardless of the magnitude of the phase (in the vicinity of the output power Pout of 2500 W).

As explained above, the range of the first phase ϕ in which the iron loss Pi can be sufficiently reduced while the Idet margin being secured has width. For example, as illustrated in FIG. 30 to FIG. 32, the power conversion device 10 can set the first phase ϕ in a range of at least 30 degrees to 75 degrees and can set the first phase ϕ, for example, in a range of 30 degrees to 90 degrees. The first phase ϕ in which the iron loss Pi is sufficiently reduced while the Idet margin being secured varies according to the output voltage Vout, the output current Iout, the input voltage Vin, or the circuit temperature T.

Therefore, in the first modification, the power conversion device 10 sets the magnitude of the first phase ϕ according to the output voltage Vout, the output current Iout, the input voltage Vin, or the circuit temperature T in the second mode. Consequently, the power conversion device 10 according to the first modification can secure the Idet margin, reliably avoid hard switching, and reduce the iron loss Pi.

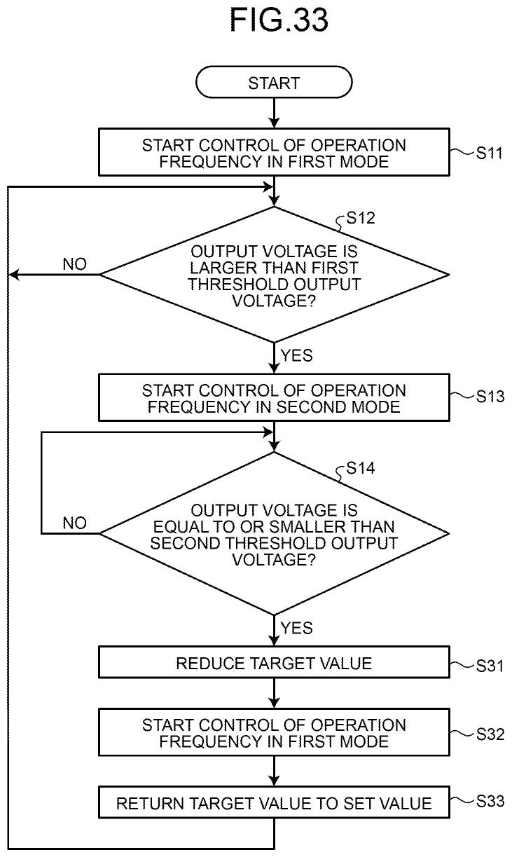

FIG. 33 is a flowchart illustrating processing of the controller 46 in a second modification.

In the second mode, when the output voltage Vout is equal to or smaller than the second threshold output voltage (Yes in S14), the controller 46 advances the processing to S31.

In S31, the controller 46 reduces a target value of the output current Iout or the output power Pout by a predetermined amount. Consequently, the controller 46 can reduce the output current Iout. When finishing S31, the controller 46 advances the processing to S32.

In S32, the controller 46 starts control of the operation frequency fc in the first mode. The processing in S32 is similar to the processing in S11. Following S32, the controller 46 advances the processing to S33.

In S33, the controller 46 returns the target value of the output current Iout or the output power Pout to a preset value. Consequently, the controller 46 can return the output current Iout to a preset target value. When finishing S33, the controller 46 returns the processing to S12 and repeats the processing from S12.

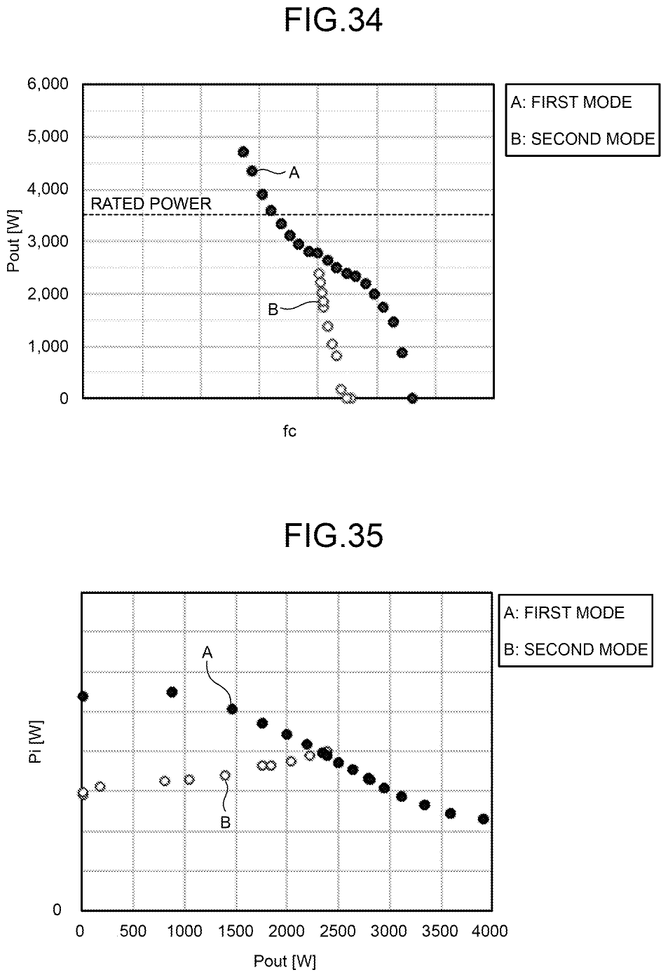

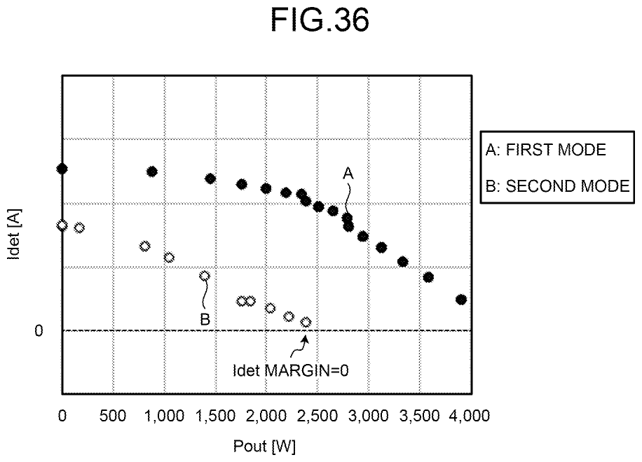

FIG. 34 is a diagram illustrating a characteristic of the output power Pout with respect to the operation frequency fc. FIG. 35 is a diagram illustrating a characteristic of the iron loss Pi with respect to the output power Pout. FIG. 36 is a diagram illustrating a characteristic of the Idet margin with respect to the output power Pout. A indicates a characteristic in the first mode and B indicates a characteristic in the second mode.

In a situation where the operation frequency fc is fixed, for example, when the output current Iout has not changed but the output voltage Vout has increased and the power conversion device 10 has switched the first mode to the second mode, the output power Pout decreases, the iron loss Pi decreases, and the Idet margin decreases.

In the power conversion device 10, an operation in a direction in which the output power Pout decreases and an operation in a direction in which the iron loss Pi decreases are operations in a safe direction for a circuit. In contrast, in the power conversion device 10, an operation in a direction in which the Idet margin decreases is an operation in an unstable direction for the circuit.

However, since the power conversion device 10 switches the first mode to the second mode within an operation range in which the Idet margin is secured, there is no problem in the operation in the direction in which the Idet margin decreases. The output current Iout instantaneously decreases immediately after the power conversion device 10 switches the first mode to the second mode, but there is no problem because the power conversion device 10 controls the output power Pout or the output current Iout to be set to the target value in the subsequent control.

On the other hand, in the situation in which the operation frequency fc is fixed, for example, when the output current Iout has not changed but the output voltage Vout has decreased and the power conversion device 10 switches the second mode to the first mode, the output power Pout increases, the iron loss Pi increases, and the Idet margin increases.

In the power conversion device 10, an operation in a direction in which the Idet margin increases is an operation in a safe direction as the circuit. In contrast, in the power conversion device 10, an operation in a direction in which the output power Pout increases and an operation in a direction in which the iron loss Pi increases are operations in an unstable direction for the circuit. For example, when the power conversion device 10 operates in the direction in which the output power Pout increases, there is a possibility that an overcurrent instantaneously flows to the load.

Therefore, in the second modification, when switching the second mode to the first mode, the controller 46 simultaneously switches the first switch element 62 and the fourth switch element 68 and simultaneously switches the second switch element 64 and the third switch element 66 after reducing the target value by a predetermined amount. After simultaneously starting switching the first switch element 62 and the fourth switch element 68, the controller 46 returns the target value to the set value. Consequently, it is possible to cause the power conversion device 10 according to the second modification to perform switching not to feed an overcurrent to the load.

Note that, in the second modification, when switching the first mode to the second mode, after reducing the target value by a predetermined amount, the controller 46 may switch the fourth switch element 68 with the phase of the fourth switch element 68 delayed by the first phase ϕ with respect to the first switch element 62 and switch the third switch element 66 with the phase of the third switch element 66 delayed by the first phase ϕ with respect to the second switch element 64. The controller 46 may start the switching with the switching phase of the fourth switch element 68 delayed by the first phase ϕ with respect to the first switch element 62 and, thereafter, return the target value to the set value.

In the second modification, the controller 46 may increase the operation frequency fc by a predetermined amount instead of reducing the target value of the output current Iout or the output power Pout by the predetermined amount. More specifically, when switching the second mode to the first mode, the controller 46 may increase the operation frequency fc by a predetermined amount and, thereafter, simultaneously switch the first switch element 62 and the fourth switch element 68 and simultaneously switch the second switch element 64 and the third switch element 66. The controller 46 controls the operation frequency fc after simultaneously starting switching the first switch element 62 and the fourth switch element 68. In this way as well, it is possible to cause the power conversion device 10 according to the second modification to perform switching not to feed an overcurrent to the load.

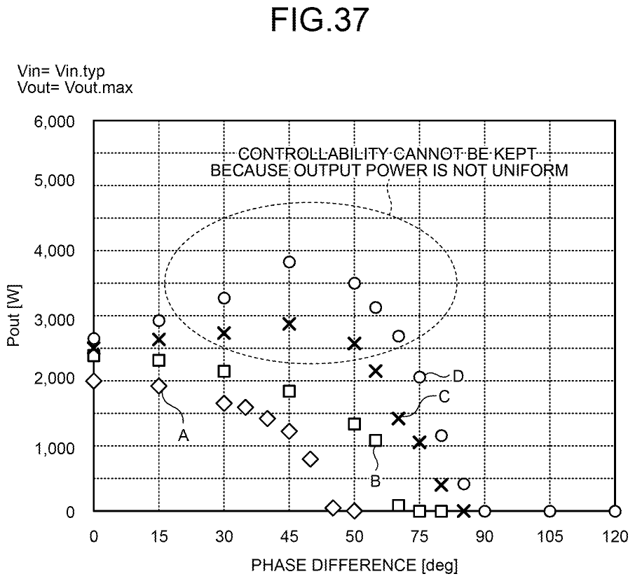

FIG. 37 is a characteristic diagram of the output power Pout with respect to a phase shift amount in the case in which phase shift control is performed with a frequency fixed by the configuration of the conventional LLC converter. A is a characteristic of the output power Pout with respect to the phase shift amount in the case in which a phase is shifted with fc fixed at 2.0 kW or less. B is a characteristic of the output power Pout with respect to the phase shift amount in the case in which the phase is shifted with fc fixed at 2.4 kW or less. C is a characteristic of the output power Pout with respect to the phase shift amount in the case in which the phase is shifted with fc fixed at 2.5 kW or less. D is a characteristic of the output power Pout with respect to the phase shift amount in the case in which the phase is shifted with fc fixed at 2.6 kW or less.

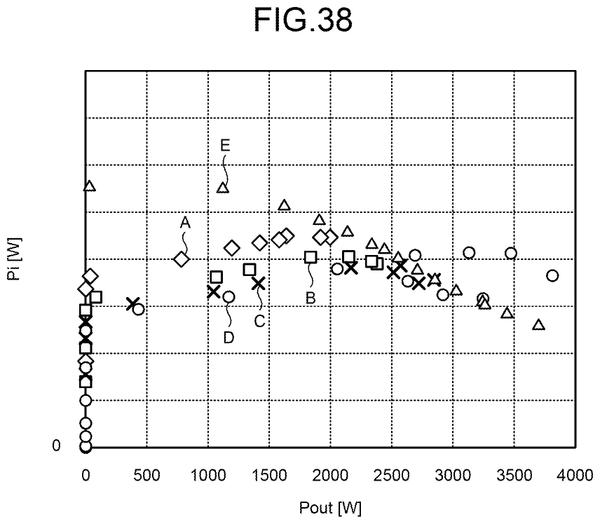

FIG. 38 is a characteristic diagram of the iron loss Pi with respect to the output power Pout at the time when the power conversion device 10 is caused to operate under the conditions of FIG. 37 by the configuration of the conventional LLC converter. A is a characteristic of the iron loss Pi with respect to the output power Pout in the case in which the phase is shifted with fc fixed at 2.0 kW or less. B is a characteristic of the iron loss Pi with respect to the output power Pout in the case in which the phase is shifted with fc fixed at 2.4 kW or less. C is a characteristic of the iron loss Pi with respect to the output power Pout in the case in which the phase is shifted with fc fixed at 2.5 kW or less. D is a characteristic of the iron loss Pi with respect to the output power Pout in the case in which the phase is shifted with fc fixed at 2.6 kW or less. E is a characteristic of the iron loss Pi with respect to the output power Pout of so-called conventional LLC control in which frequency control is performed with a phase shift amount set to 0 by the configuration of the conventional LLC converter. Here, when the phase shift control is performed at 2.4 kW or less, the output power Pout decreases as the phase shift amount is increased. The iron loss Pi is lower than that of the conventional LLC converter in this region. (FIG. 38), when the phase shift control is performed at 2.5 kW or more, the output power Pout increases when the phase shift amount is increased and the output power Pout decreases when the phase shift amount is further increased. In this case, since the output power Pout does not uniformly change with respect to the phase shift amount, controllability cannot be kept. In contrast, as illustrated in FIG. 34, when the frequency control is performed with the phase shift amount fixed, the output power Pout decreases when the frequency is increased. Since the output power Pout uniformly changes, the controllability is kept. That is, the controllability can be kept when the frequency control is performed with the phase shift amount fixed. In a region where output power is low to some extent, the controllability can be kept even if the phase shift control is performed with the frequency fixed. A reduction effect of the iron loss Pi can be obtained.

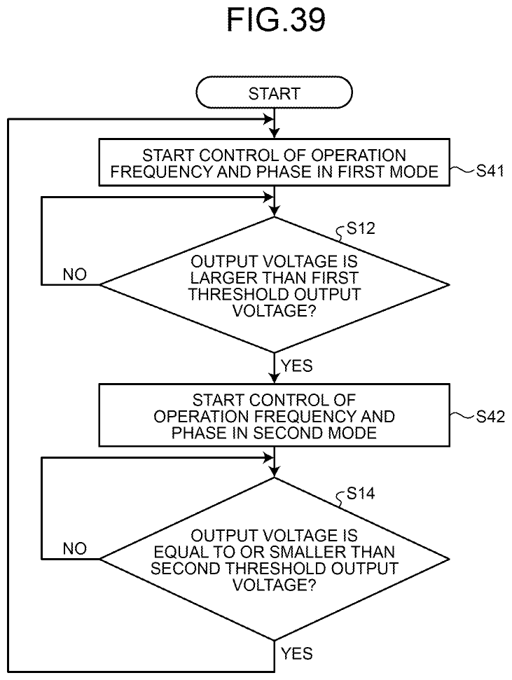

FIG. 39 is a flowchart illustrating processing of the controller 46 in a third modification.

In the third modification, the controller 46 executes processing in S41 instead of the processing in S11.

In S41, the controller 46 starts control in the first mode. That is, the controller 46 simultaneously switches the second switch element 64 and the fourth switch element 68 at the time of the control start in the first mode. Further, at the time of the control start in the first mode, the controller 46 simultaneously switches the second switch element 64 and the third switch element 66. After starting the control in the first mode, the controller 46 controls both the operation frequencies fc and the phases of the first switch element 62, the second switch element 64, the third switch element 66, and the fourth switch element 68 to set the output current Iout or the output power Pout to a preset target value.

In the third modification, the controller 46 executes processing in S42 instead of the processing of S13.

In S42, the controller 46 starts control in the second mode. That is, at the time of the control start in the second mode, the controller 46 delays the phase of the fourth switch element 68 by the first phase ϕ with respect to the first switch element 62 and switches the fourth switch element 68. At the time of the control start in the second mode, the controller 46 delays the phase of the third switch element 66 by the first phase ϕ with respect to the second switch element 64 and switches the third switch element 66. After starting the control in the second mode, the controller 46 controls both the operation frequencies fc and the phases of the first switch element 62, the second switch element 64, the third switch element 66, and the fourth switch element 68 to set the output current Iout or the output power Pout to the preset target value.

The power conversion device 10 according to the fourth modification can also reduce the iron loss Pi in the transformer 38. Therefore, the power conversion device 10 according to the third modification can efficiently perform power conversion with simple control.

Note that, in the third modification, after starting the control in the first mode, the controller 46 may fix the operation frequencies fc of the first switch element 62, the second switch element 64, the third switch element 66, and the fourth switch element 68 and control the phases to set the output current Iout or the output power Pout to the preset target value. After starting the control in the second mode, the controller 46 may fix the operation frequencies fc of the first switch element 62, the second switch element 64, the third switch element 66, and the fourth switch element 68 and control the phases to set the output current Iout or the output power Pout to the preset target value.

Besides, the above embodiments are merely examples of embodiment in implementing the present disclosure. The technical scope of the present disclosure should not be limitedly interpreted by these embodiments. That is, the present disclosure can be implemented in various forms without departing from the gist or main features thereof.

For example, the power conversion device 10 explained above may be provided in a vehicle such as an electric vehicle. In this case, the power conversion device 10 is supplied with AC power or DC power from a charging stand or the like and supplies the output power Pout to a lithium ion battery or the like provided in the vehicle.

With the power conversion device, the vehicle, the control method, and the computer program product according to the present disclosure, it is possible to efficiently perform power conversion with simple control.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power conversion device in which a DC input voltage is applied between a positive-side input terminal and a negative-side input terminal and a DC output voltage is output from between a positive-side output terminal and a negative-side output terminal connected to a load, the power conversion device comprising:
a first switch element connected between the positive-side input terminal and a first intermediate terminal;
a second switch element connected between the first intermediate terminal and the negative-side input terminal;
a third switch element connected between the positive-side input terminal and a second intermediate terminal;
a fourth switch element connected between the second intermediate terminal and the negative-side input terminal;
a resonance circuit including an inductor and a capacitor;
a transformer in which a primary-side coil is connected between the first intermediate terminal and the second intermediate terminal such that the inductor, the capacitor, and the primary-side coil are connected in series;
a rectifier circuit configured to rectify a voltage output from a secondary-side coil of the transformer;
a smoothing circuit configured to smooth a voltage output from the rectifier circuit and output the smoothed voltage between the positive-side output terminal and the negative-side output terminal; and
a controller configured to complementarily switch the first switch element and the second switch element with an operation frequency and complementarily switch the third switch element and the fourth switch element with the operation frequency,
the controller being configured to:
control the operation frequency to set an output current supplied to the load or output power supplied to the load to a preset target value;
simultaneously switch the first switch element and the fourth switch element in a first mode;
switch the fourth switch element with a phase of the fourth switch element delayed by a predetermined first phase with respect to the first switch element in a second mode; and
switch the first mode and the second mode according to at least one of the output voltage, the output current, a dead time current flowing to the inductor in a dead time from when the fourth switch element becomes nonconductive until when the third switch element is conducted, the input voltage, and a circuit temperature, which is a temperature of the transformer.

2. The power conversion device according to claim 1, wherein,
in the first mode, the controller is configured to switch the first mode to the second mode when the output voltage is larger than a predetermined first threshold output voltage, when the output current is smaller than a predetermined first threshold output current, when the dead time current in the dead time from when the fourth switch element becomes nonconductive until when the third switch element is conducted is larger than a predetermined first threshold excitation current, when the input voltage is larger than a predetermined first threshold input voltage, or when the circuit temperature is larger than a predetermined first threshold temperature.

3. The power conversion device according to claim 2, wherein,
in the second mode, the controller is configured to switch the second mode to the first mode when the output voltage is equal to or smaller than a predetermined second threshold output voltage, when the output current is equal to or larger than a predetermined second threshold output current, when the dead time current in the dead time from when the fourth switch element becomes nonconductive until when the third switch element is conducted is equal to or smaller than a predetermined second threshold excitation current, when the input voltage is equal to or smaller than a predetermined second threshold input voltage, or when the circuit temperature is equal to or smaller than a predetermined second threshold temperature.

4. The power conversion device according to claim 1, wherein
the controller is configured to switch the first mode to the second mode when the output voltage is larger than a predetermined first threshold output voltage and the output current is smaller than a predetermined first threshold output current.

5. The power conversion device according to claim 1, wherein
the controller is configured to switch the first mode to the second mode when the output voltage is larger than a predetermined first threshold output voltage, the output current is smaller than a predetermined first threshold output current, and the dead time current is larger than a predetermined first threshold excitation current.

6. The power conversion device according to claim 1, wherein,
in the second mode, the controller is configured to set magnitude of the first phase according to the output voltage, the output current, the input voltage, the dead time current, or the circuit temperature.

7. The power conversion device according to claim 1, wherein,
when switching the second mode to the first mode, the controller is configured to simultaneously switch the first switch element and the fourth switch element after reducing the target value by a predetermined amount, and return the target value to a set value after simultaneously starting switching the first switch element and the fourth switch element.

8. The power conversion device according to claim 7, wherein,
when switching the first mode to the second mode, the controller is configured to switch the fourth switch element with a phase of switching of the fourth switch element delayed by the first phase with respect to the first switch element after reducing the target value by the predetermined amount, and return the target value to the set value after starting switching the fourth switch element with the phase of switching of the fourth switch element delayed by the first phase with respect to the first switch element.

9. The power conversion device according to claim 1, wherein,
when switching the first mode to the second mode, the controller is configured to increase a phase of switching of the fourth switch element with respect to the first switch element from 0 to the first phase according to lapse of time.

10. The power conversion device according to claim 1, wherein,
when switching the second mode to the first mode, the controller is configured to reduce a phase of switching of the fourth switch element with respect to the first switch element from the first phase to 0 according to lapse of time.

11. The power conversion device according to claim 3, wherein
the second threshold output voltage is smaller than the first threshold output voltage,
the second threshold output current is larger than the first threshold output current,
the second threshold excitation current is smaller than the first threshold excitation current,
the second threshold input voltage is smaller than the first threshold input voltage, and
the second threshold temperature is lower than the first threshold temperature.

12. The power conversion device according to claim 1, wherein
each of the first switch element and the second switch element includes a MOSFET (metal-oxide-semiconductor field effect transistor) configured by a Si semiconductor, and
a recovery characteristic of a body diode of each of the third switch element and the fourth switch element is higher than that of each of the first switch element and the second switch element.

13. A power conversion device in which a DC input voltage is applied between a positive-side input terminal and a negative-side input terminal and a DC output voltage is output from between a positive-side output terminal and a negative-side output terminal connected to a load, the power conversion device comprising:
a first switch element connected between the positive-side input terminal and a first intermediate terminal;
a second switch element connected between the first intermediate terminal and the negative-side input terminal;
a third switch element connected between the positive-side input terminal and a second intermediate terminal;
a fourth switch element connected between the second intermediate terminal and the negative-side input terminal;
a resonance circuit including an inductor and a capacitor;
a transformer in which a primary-side coil is connected between the first intermediate terminal and the second intermediate terminal such that the inductor, the capacitor, and the primary-side coil are connected in series;
a rectifier circuit configured to rectify a voltage output from a secondary-side coil of the transformer;
a smoothing circuit configured to smooth a voltage output from the rectifier circuit and output the smoothed voltage between the positive-side output terminal and the negative-side output terminal; and
a controller configured to complementarily switch the first switch element and the second switch element with an operation frequency and complementarily switch the third switch element and the fourth switch element with the operation frequency,
the controller being configured to:
control the operation frequency and a phase of the fourth switch element with respect to the first switch element to set an output current supplied to the load or output power supplied to the load to a preset target value; and
when the output voltage is larger than a predetermined first threshold output voltage, when the output current is smaller than a predetermined first threshold output current, when a dead time current flowing to the inductor in a dead time from when the fourth switch element becomes nonconductive until when the third switch element is conducted is larger than a predetermined first threshold excitation current, when the input voltage is larger than a predetermined first threshold input voltage, or when a circuit temperature that is a temperature of the transformer is larger than a predetermined first threshold temperature, after delaying the phase of switching of the fourth switch element with respect to the first switch element by a predetermined first phase, control the operation frequency and the phase.

14. A power conversion device in which a DC input voltage is applied between a positive-side input terminal and a negative-side input terminal and a DC output voltage is output from between a positive-side output terminal and a negative-side output terminal connected to a load, the power conversion device comprising:
a first switch element connected between the positive-side input terminal and a first intermediate terminal;
a second switch element connected between the first intermediate terminal and the negative-side input terminal;
a third switch element connected between the positive-side input terminal and a second intermediate terminal;
a fourth switch element connected between the second intermediate terminal and the negative-side input terminal;
a resonance circuit including an inductor and a capacitor;
a transformer in which a primary-side coil is connected between the first intermediate terminal and the second intermediate terminal such that the inductor, the capacitor, and the primary-side coil are connected in series;
a rectifier circuit configured to rectify a voltage output from a secondary-side coil of the transformer;
a smoothing circuit configured to smooth a voltage output from the rectifier circuit and output the smoothed voltage between the positive-side output terminal and the negative-side output terminal; and
a controller configured to complementarily switch the first switch element and the second switch element with an operation frequency and complementarily switch the third switch element and the fourth switch element with the operation frequency,
the controller being configured to:
control a phase of the fourth switch element with respect to the first switch element to set an output current supplied to the load or output power supplied to the load to a preset target value; and
when the output voltage is larger than a predetermined first threshold output voltage, when the output current is smaller than a predetermined first threshold output current, when a dead time current flowing to the inductor in a dead time from when the fourth switch element becomes nonconductive until when the third switch element is conducted is larger than a predetermined first threshold excitation current, when the input voltage is larger than a predetermined first threshold input voltage, or when a circuit temperature that is a temperature of the transformer is larger than a predetermined first threshold temperature, after delaying the phase of switching of the fourth switch element with respect to the first switch element by a predetermined first phase, control the phase.

15. A control method in a power conversion device in which a DC input voltage is applied between a positive-side input terminal and a negative-side input terminal and a DC output voltage is output from between a positive-side output terminal and a negative-side output terminal connected to a load,
the power conversion device including:
a first switch element connected between the positive-side input terminal and a first intermediate terminal;
a second switch element connected between the first intermediate terminal and the negative-side input terminal;
a third switch element connected between the positive-side input terminal and a second intermediate terminal;
a fourth switch element connected between the second intermediate terminal and the negative-side input terminal;
a resonance circuit including an inductor and a capacitor;
a transformer in which a primary-side coil is connected between the first intermediate terminal and the second intermediate terminal such that the inductor, the capacitor, and the primary-side coil are connected in series;
a rectifier circuit configured to rectify a voltage output from a secondary-side coil of the transformer;
a smoothing circuit configured to smooth a voltage output from the rectifier circuit and output the smoothed voltage between the positive-side output terminal and the negative-side output terminal; and
a controller configured to complementarily switch the first switch element and the second switch element with an operation frequency and complementarily switch the third switch element and the fourth switch element with the operation frequency,
the control method, by the controller, comprising:
controlling the operation frequency to set an output current supplied to the load or output power supplied to the load to a preset target value;
simultaneously switching the first switch element and the fourth switch element in a first mode;
switching the fourth switch element with a phase of the fourth switch element delayed by a predetermined first phase with respect to the first switch element in a second mode; and
switching the first mode and the second mode according to at least one of the output voltage, the output current, a dead time current flowing to the inductor in a dead time from when the fourth switch element becomes nonconductive until when the third switch element is conducted, the input voltage, and a circuit temperature, which is a temperature of the transformer.
